(19) United States
(12) Patent Application Publication
(10) Pub. No.: US 2025/0334535 A1
(43) Pub. Date: Oct. 30, 2025

(54) SYSTEM, METHOD AND DEVICE FOR DETERMINING THE IMPEDANCE PROPERTIES OF A DEVICE UNDER TEST

(71) Applicant: 2778026 Ontario Corp., Toronto (CA)

(72) Inventors: Essam Samir Elsahwi, Toronto (CA); Benjamin Maxwell, East York (CA); Mariam Awara, Toronto (CA)

(21) Appl. No.: 19/192,421

(22) Filed: Apr. 29, 2025

Related U.S. Application Data
(60) Provisional application No. 63/640,281, filed on Apr. 30, 2024.

(51) Int. Cl. G01N 27/02; H01F 27/28

(52) U.S. Cl. CPC G01N 27/026; H01F 27/28

(57) ABSTRACT

System, method and device for measuring the impedance properties of a device under test (DUT). The primary winding of a transformer may be coupled in series between a power supply or sink and an output connectable to the DUT. A variable AC generator is configured to generate an analysis signal. A controller is operably connectable to a first sensor that measures at least one attribute of the device under test. The controller receives a first input signal from the first sensor and determines the impedance properties of the device under test. The system is operable in a first mode and a second mode. When the system is in the first mode the variable AC generator is coupled to the DUT to apply the analysis signal to the DUT and a controlled energy device is coupled in series between the variable AC generator and the DUT.

### CROSS-REFERENCE TO RELATED APPLICATIONS

This application claims benefit of U.S. Provisional Application No. 63/640,281 filed on Apr. 30, 2024, which is incorporated by reference herein in its entirety.

### FIELD

The present disclosure relates to determining the properties of a device under test, and in particular, to systems, methods and devices for determining the impedance properties of a device under test.

### BACKGROUND

In recent years, impedance spectroscopy has found increasing wide-spread application as a non-invasive, and non-intrusive technique for monitoring state and health properties of electrical, electrochemical, and biological loads and sources.

In impedance spectroscopy, a device under test is injected (e.g., interrogated or perturbed or excited) with one or more alternating-current (AC) signals characterized by different frequencies, or having different frequency components. An impedance spectrum may then be generated by plotting the impedance response of the device under test as a function of the applied frequencies. In various cases, the impedance spectrum is then analyzed to determine electrical, physical, chemical, and biological properties of the interrogated device.

### SUMMARY

In a broad aspect, there is provided a system for analysing a device under test, the system comprising: a transformer having at least one primary winding and at least one secondary winding; the at least one primary winding of the transformer being coupled in series between a power supply or sink and an output connectable to a device under test, wherein the power supply or sink is operable in a power supply mode to generate a DC current across the at least one primary winding to power the device under test and the power supply or sink is operable in a power sink mode to dissipate electrical energy from the device under test; a variable alternating-current (AC) generator configured to generate at least one device analysis signal; and a controller operably connectable to at least one first sensor, wherein the at least one first sensor is configured to measure at least one attribute of the device under test, wherein the controller is configured to receive a first input signal from the at least one first sensor; wherein the system is operable in a first mode and a second mode, wherein when the system is in the first mode the variable AC generator is coupled to the device under test to apply the at least one analysis signal to the device and a controlled energy device is coupled in series between the variable AC generator and the device under test.

The controller may be configured to determine the impedance properties of the device under test based on the first input signal.

When the system is in the first mode, the at least one secondary winding can be disconnected.

When the system is in the second mode, the variable AC generator can be coupled in-series to the at least one secondary winding.

When the system is in the second mode the controlled energy device can be coupled to the device under test in parallel with the power supply or sink.

The controller may be connectable to the at least one first sensor by a data cable.

The controller may be operable to provide power to the at least one first sensor through the data cable.

The controller may be operably connectable to a first measurement device, where the first measurement device includes the at least one first sensor, the at least one first sensor includes a plurality of first sensors, and each first sensor is operably connectable to a different corresponding load or source of the device under test.

The system can include an external switch network, where the controller is selectively connectable to a plurality of measurement devices via the external switch network.

Each measurement device can include a corresponding plurality of first sensors, and each first sensor can be operably connectable to a different corresponding or source of the device under test.

The external switch network can include a plurality of external switches, and the plurality of external switches can be connected to the controller in a series with each external switch coupled to at least one adjacent external switch in the series.

The plurality of external switches can be daisy-chained to the controller.

The controller can be connectable to each switch in the switch network by at least one data cable.

The controller can be operable to provide synchronization data to each measurement device through the at least one data cable.

The system can include at least one additional external switch network, where the controller is selectively connectable to an additional plurality of measurement devices via each additional external switch network.

The controller can include a plurality of data ports, and the controller can be connectable to each external switch network through a different data port in the plurality of data ports.

The controller can be detachably attachable to the external switch network.

Each first sensor can include a first voltage sensor connectable in parallel arrangement to the corresponding load or source of the device under test.

The transformer, variable AC generator, controller and controlled energy device can be provided by a portable analysis device.

The at least one first sensor can remain connected to the load or source of the device under test.

The power supply or sink can be a bidirectional power supply.

In a broad aspect, there is provided a system for analysing a device under test, the system comprising: a variable alternating-current (AC) generator configured to generate at least one device analysis signal; an output connectable to a device under test; and a controller operably connectable to at least one first sensor, wherein the at least one first sensor is configured to measure at least one attribute of the device under test, wherein the controller is configured to receive a first input signal from the at least one first sensor and is further configured to determine the impedance properties of the device under test based on the first input signal, wherein the variable AC generator is coupled to the device under test to apply the at least one analysis signal to the device.

The controller may be configured to determine impedance properties of the device under test based on the first input signal.

The system can include a controlled energy device coupled in series between the variable AC generator and the device under test, wherein the controlled energy device generates at least one of the at least one analysis signal.

The controller may be connectable to the at least one first sensor by a data cable.

The controller may be operable to provide power to the at least one first sensor through the data cable.

The controller may be operably connectable to a first measurement device, wherein the first measurement device may include at least one first sensor, the at least one first sensor comprises a plurality of first sensors, and each first sensor may be operably connectable to a different corresponding load or source of the device under test.

The system may include an external switch network and the controller may selectively connectable to a plurality of measurement devices via the external switch network.

Each measurement device may include a corresponding plurality of first sensors, and each first sensor may be operably connectable to a different corresponding load or source of the device under test.

The external switch network may include a plurality of external switches, and the plurality of external switches may be connected to the controller in a series with each external switch coupled to at least one adjacent external switch in the series.

The external switches may be daisy-chained to the controller.

The controller may be connectable to each switch in the switch network by at least one data cable.

The controller may be operable to provide synchronization data to each measurement device through the at least one data cable.

The system may include at least one additional external switch network, wherein the controller may be selectively connectable to an additional plurality of measurement devices via each additional external switch network.

The controller may include a plurality of data ports, and the controller may be connectable to each external switch network through a different data port in the plurality of data ports.

The controller may be detachably attachable to the external switch network.

Each first sensor may comprise a first voltage sensor connectable in parallel arrangement to the corresponding load or source of the device under test.

The variable AC generator, controller or controlled energy device, or all of them, may be provided by a portable analysis device.

The at least one first sensor may remain connected to the load or source of the device under test.

In a broad aspect, there is provided a system for measuring impedance properties of a device under test comprising a plurality of loads or sources, the system comprising: a plurality of sensors, each sensor connectable to a corresponding load or source in the plurality of loads or sources; a variable alternating-current (AC) generator configured to generate at least one analysis signal, wherein the variable AC generator is connectable to the device under test to apply the at least one analysis signal to the plurality of loads or sources; a controller; and a switch network; wherein the controller is selectively connectable to each sensor in the plurality of sensors via the switch network; and the controller is configured to, for each sensor in the plurality of sensors: receive an input signal from that sensor; and determine the impedance properties of the corresponding load or source based on the input signal.

The system can include a plurality of measurement devices, where each measurement device can include a corresponding plurality of device sensors from the plurality of sensors, and the controller is selectively connectable to each measurement device via the switch network.

The controller can be connected to each switch in the switch network by at least one data cable.

The controller can be operable to provide synchronization data to each measurement device through the at least one data cable.

The plurality of sensors can be powered by power provided through the data cable.

The system can include at least one additional switch network, where the controller is selectively connectable to an additional plurality of measurement devices via each additional external switch network.

The controller can include a plurality of data ports, and the controller can be connectable to each external switch network through a different data port in the plurality of data ports.

Each switch network can include a plurality of switches, and the plurality of switches can be connected to the controller in a series with each switch coupled to at least one adjacent external switch in the series.

The plurality of switches can be daisy-chained to the controller.

Each first sensor can include a first voltage sensor connectable in parallel arrangement to the corresponding load or source.

The variable AC generator and the controller can be provided by a portable analysis device.

Each sensor can remain connected to the corresponding load or source.

Other features and advantages of the present application will become apparent from the following detailed description taken together with the accompanying drawings. It should be understood, however, that the detailed description and the specific examples, while indicating preferred embodiments of the application, are given by way of illustration only, since various changes and modifications within the spirit and scope of the application will become apparent to those skilled in the art from this detailed description.

### BRIEF DESCRIPTION OF THE DRAWINGS

For a better understanding of the various embodiments described herein, and to show more clearly how these various embodiments may be carried into effect, reference will be made, by way of example, to the accompanying drawings which show at least one example embodiment and the figures will now be briefly described.

FIG. 1 illustrates a simplified block diagram of an example impedance determining system;

FIG. 2A illustrates a simplified circuit diagram of an example analysis signal generator that can be used in the impedance determining system of FIG. 1;

FIG. 2B illustrates a simplified circuit diagram of another example analysis signal generator that can be used in the impedance determining system of FIG. 1;

FIG. 2C illustrates a simplified circuit diagram of another example analysis signal generator including an example internal switch network;

FIG. 2D illustrates a simplified circuit diagram of another example analysis signal generator that can be used in the impedance determining system of FIG. 1;

FIG. 2E illustrates a simplified circuit diagram of another example analysis signal generator that can be used in the impedance determining system of FIG. 1;

FIG. 2F illustrates a simplified circuit diagram of another example analysis signal generator that can be used in the impedance determining system of FIG. 1;

FIG. 2G illustrates a simplified circuit diagram of another example analysis signal generator that can be used in the impedance determining system of FIG. 1;

FIG. 2H illustrates a simplified circuit diagram of another example analysis signal generator;

FIG. 2J illustrates a simplified circuit diagram of another example analysis signal generator;

FIG. 3 illustrates a simplified block diagram of an example switch network that can be used in the impedance determining system of FIG. 1;

FIG. 4A illustrates a simplified block diagram of an example impedance determining system that includes an analysis device and an external switch network;

FIG. 4B illustrates a simplified block diagram of another example impedance determining system that includes an analysis device and an external switch network;

FIG. 4C illustrates a simplified block diagram of another example impedance determining system that includes an analysis device and an external switch network;

FIG. 5 illustrates a simplified block diagram of an example controller that can be used in the impedance determining system of FIG. 1;

FIG. 6A illustrates a flowchart of an example method that can be performed using the impedance determining system of FIG. 1; and

FIG. 6B illustrates a flowchart of another example method that can be performed using the impedance determining system of FIG. 1.

The skilled person in the art will understand that the drawings, described below, are for illustration purposes only. The drawings are not intended to limit the scope of the applicants' teachings in anyway. Also, it will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

Various systems, apparatuses or processes will be described below to provide an example of various embodiments of the claimed subject matter. No embodiment described below limits any claimed subject matter and any claimed subject matter may cover processes, apparatuses, devices, or systems that differ from those described below. The claimed subject matter is not limited to apparatuses, devices, systems, or processes having all of the features of any one apparatus, device, system, or process described below or to features common to multiple or all of the apparatuses, devices, systems, or processes described below. It is possible that an apparatus, device, system, or process described below is not an embodiment of any claimed subject matter. Any subject matter that is disclosed in an apparatus, device, system, or process described below that is not claimed in this document may be the subject matter of another protective instrument, for example, a continuing patent application, and the applicants, inventors, or owners do not intend to abandon, disclaim, or dedicate to the public any such subject matter by its disclosure in this document.

Furthermore, it will be appreciated that for simplicity and clarity of illustration, where considered appropriate, reference numerals may be repeated among the figures to indicate corresponding or analogous elements. Figures illustrating different embodiments may include corresponding reference numerals to identify similar or corresponding components or elements. In addition, numerous specific details are set forth in order to provide a thorough understanding of the example embodiments described herein. However, it will be understood by those of ordinary skill in the art that the example embodiments described herein may be practiced without these specific details. In other instances, well-known methods, procedures, and components have not been described in detail so as not to obscure the example embodiments described herein. Also, the description is not to be considered as limiting the scope of the example embodiments described herein.

It should also be noted that the terms “coupled” or “coupling” as used herein can have several different meanings depending in the context in which the term is used. For example, as used herein, the terms “coupled” or “coupling” can indicate that two elements or devices can be directly coupled to one another or indirectly coupled to one another through one or more intermediate elements or devices via an electrical element, electromagnetic element, electrical signal, or a mechanical element such as but not limited to, a wire or cable, for example, depending on the particular context. Elements and devices may also be coupled wireless to permit communication using any wireless communication standard. For example, devices may be coupled wirelessly using Bluetooth communication, WiFi or another standard or proprietary wireless communication protocol.

It should be noted that terms of degree such as “substantially”, “about”, and “approximately” as used herein mean a reasonable amount of deviation of the modified term such that the end result is not significantly changed. These terms of degree should be construed as including a deviation of the modified term if this deviation would not negate the meaning of the term it modifies.

Furthermore, the recitation of any numerical ranges by endpoints herein includes all numbers and fractions subsumed within that range (e.g., 1 to 5 includes 1, 1.5, 2, 2.75, 3, 3.90, 4, and 5). It is also to be understood that all numbers and fractions thereof are presumed to be modified by the term “about” which means a variation up to a certain amount of the number to which reference is being made if the end result is not significantly changed.

Impedance spectroscopy has found increasing wide-spread application as a non-invasive, and non-intrusive technique for monitoring state and health properties of various loads and/or sources of electrical, electrochemical, and biological nature. In general herein, the term “device under test” is used to refer to one or more electrical or electrochemical or biological loads or one or more electrical or electrochemical or biological sources that may undergo signal analysis to identify the impedance properties.

During impedance spectroscopy, a device under test (DUT) is injected (e.g., interrogated or perturbed) with one or more alternating-current (AC) signals characterized by different frequencies, or having different frequency components. At each applied frequency, the voltage and current response of the device under test is measured and the impedance (or complex resistance) of the device under test is determined in accordance with Equation (1):

$$Z ( ω ) = \frac{\hat{E} ( ω )}{\hat{I} ( ω )} \qquad ( 1 )$$

wherein Z is the impedance of the device under test as a function of the applied frequency (ω), Ê is the measured potential across the device under test, and Î is the measured current flowing through the device under test.

A device impedance spectrum may then be generated by plotting the calculated impedance response as a function of the applied frequencies (ω). For example, the impedance spectrum can be plotted in the form of a real impedance versus imaginary impedance plot or a Bode plot.

The impedance data (plotted as a spectrum or in raw form) often provides valuable information regarding electrical, physical, chemical, and biological properties of the device under test. For example, the device's impedance spectrum can be compared against an ideal (or expected) impedance spectrum to diagnose faults in the device's performance. The impedance spectrum can also be used to generate an equivalent circuit model of the device (e.g., a small signal model), which provides insights regarding the device's operation, as well as the device's physical or electrical structure.

The equivalent circuit model may also be used to validate physics-based theoretical models of the device which are derived from first principles. This can be used to determine quality of devices at end of line applications or to inform new device designs and methodologies. The impedance data may also be used to develop statistical methods and models to evaluate the health and performance of DUT in operation or in an end of line application.

Electrical loads and electrical sources which may be the subject of impedance spectroscopy (i.e. the device under test) include, for example, motors, generators, capacitors, cables, inductors, or transformers, power supplies (DC/AC), electronic loads (DC/AC).

Impedance spectroscopy may also be performed on electrochemical loads and sources in a technique known as electrochemical impedance spectroscopy (EIS). Electrochemical devices under test may include, for example, batteries (e.g., rechargeable batteries), fuel cells, electrolyzers, as well as membranes employed in membrane-based waste water treatment (e.g., reverse osmosis (RO) membranes). EIS may be used to measure various physical phenomena that occur over varying time scales within the electrochemical devices. For instance, EIS may be used to measure fast phenomena that occur within the electrochemical device over shorter time scales (such as electron transfer), or slower phenomena that occur within the device over longer times scales (such as corrosion). For example, EIS may be used to determine the state of charge of a battery, electrochemical reactions occurring within batteries and fuel cells (e.g., diffusion and charge-transfer), corrosion of metals, feed flow and recovery rates of membranes used in wastewater treatment, as well as organic and inorganic fouling of these membrane. Other properties of electrochemical devices which may also be determined using EIS include: solution resistance, electrode morphology, double-layer capacitance, charge-transfer resistance, and coating capacitance.

Impedance spectroscopy can also be performed on biological loads in a technique known as bioimpedance spectroscopy. For example, impedance spectroscopy may be used on biological loads such as cells or membranes to determine cell and/or membrane structure, composition, and density.

Different frequency ranges may be required in order to evaluate or model different properties of a device under test. For example, low frequency ranges may be used to evaluate physical device phenomena which occur over longer time scales, while high frequency ranges can be used to evaluate physical device phenomena which occur over shorter time scales. Examples of applications that may require the use of high frequency ranges include measurement of solution resistance, as well as measurement of the dielectric of materials (e.g., especially at industrial scales). Other applications which may require the use of lower frequency ranges include the measurement of corrosion effects. Accordingly, it is often necessary to interrogate a device under test using a wide range of frequencies in order to evaluate phenomena over a wide range of time scales and to generate an impedance spectrum containing sufficient information.

In conventional systems for impedance spectroscopy which are used in industrial applications, a device under test is coupled to a power converter, such as a switch-mode power supply (SMPS). The SMPS may be configured to convert regulated or unregulated power to a desired regulated DC voltage output for powering the device under test. In other cases, the SMPS may convert a regulated DC input voltage into a desired regulated DC output voltage. The DC/DC conversion can be performed changing the duty cycle and/or the switching frequency of the converter. The act of modulating the duty cycle or the switching frequency can cause an AC signal at the output that can be applied to a device under test.

For example, to effect the conversion, the converter can include a switching device (e.g., a metal-oxide semiconductor field effect transistor (MOSFET), or an insulated-gate bipolar transistor (IGBT)) which alternates between an ON mode and an OFF mode according to a switching frequency. The switching of the transistor device results in a small AC ripple which is imposed over the DC output. When employed in impedance spectroscopy, the switching frequency or the duty cycle is varied to generate different frequencies of AC signals. The load's impedance response is then determined as a function of the applied AC frequency.

Conventional industrial impedance spectroscopy systems, however, suffer from a number of drawbacks. For example, the maximum usable output AC ripple frequency, generated by the power converter, is limited to the Nyquist rate (e.g., half the switching frequency). Further, the effective or functional bandwidth of AC ripple frequencies generated by the spectroscopy system (e.g., the bandwidth which avoids issues, such as sampling aliasing) is typically only one-tenth (or one-twentieth) of the Nyquist rate. Accordingly, standard industrial SMPS devices that are configured for maximum switching frequencies of 10 KHz to 300 KHz may only generate an effective bandwidth of AC ripple frequency of between 0.5 KHz to 15 KHz. As a result, determining device impedance data at high frequency ranges may not be possible using only the limited effective frequency bandwidth that is generated using these power converter. Further, and in many cases, as the AC ripple is dependent on the switching frequency of the power supply, conventional industrial spectroscopy systems offer limited control over the amplitude, phase and frequency components of the output AC ripple.

Typically, an SMPS or other converter that is configured to output DC current or DC voltage is designed to minimize the AC ripple such that the output current is a high-quality DC signal. This design imperative involves increasing the switching frequency and applying analog filtering to the output. This configuration limits the ability to use the same SMPS or converter to perform spectroscopy as the analog filtering inhibits or prevents the output of an appropriate AC analysis signal.

A further drawback is that operating power converters at high switching frequencies may also result in significant power loss. For example, the switching loss of a transistor increases in proportion to the switching frequency, and may be significant at very high frequency (VHF) ranges (e.g., megahertz (MHz) ranges). Switching loss can impair the efficiency of the power converter, and may result in the transistor generating excessive heat (e.g., which may cause the converter to require a larger heat sink).

Still a further drawback of conventional industrial impedance spectroscopy systems is the inverse correlation between the power level of the converter and the maximum switching frequency. In particular, when the power supply/source is used for powering large loads, the power supply might be restricted to low (5-30 kHz) switching frequencies due to a lack of available components that can manage both the level of power demand (power rating) of the load as well as the operation of the converter at the higher frequency. Accordingly, the frequency ranges generated by the industrial spectroscopy system may be limited by the power level of the converter.

The present disclosure provides a device analysis signal generator which is configured to generate device analysis signals having frequencies, or frequency components, within a wide frequency range. The signal generator can be used, for example, in impedance spectroscopy for determining the impedance properties of a device under test (e.g. a load or source) over a wide frequency spectrum. Alternatively or in addition, the device analysis signal generator may be used to impose sinusoidal or transient changes to a device that may have positive effects (e.g., improvements) to the functioning or operation of the device system.

The device analysis signal generator may also be used to evaluate a non-operational device under test (e.g. to perform end-of-line testing). The DUT can be disconnected from any power supply/power source such that no DC current is flowing (although there may be a voltage present depending on the type of DUT being interrogated, such as a charge battery for example). The analysis signal generator can then provide the sole source of AC current through the DUT.

As explained in further detail herein, the device analysis signal generator includes a multi-winding transformer having at least one primary winding and at least one secondary winding. The at least one primary winding is in series connection between a power supply and/or sink and one or more interrogated devices under test. When the device under test includes one or more loads, a DC current—generated by the power supply—can flow across the at least one primary winding to power the load(s). When the device under test includes one or more sources, the power sink dissipates energy from the source(s) being analyzed. Optionally, a bidirectional power supply can be used that can operate as a power supply or sink depending on the desired operational mode.

The device analysis signal generator also includes a variable AC generator that generates (or induces) one or more device analysis signals. The device analysis signals can be injected into the device under test (optionally superimposed over a DC current from the power source e.g. if the device under test is a load). The frequency of the device analysis signals may be varied and the impedance properties of the device may be determined at different frequencies of the device analysis signal. Alternatively or in addition, the device analysis signal may include more than one frequency component, and the impedance response of the device may be determined in relation to each frequency component.

In general, the device analysis signal generator can be configured to ensure that the path from the variable AC generator to the device under test is a low impedance path. That is, the power source/sink can be arranged in parallel with the device under test. Accordingly, ensuring that the current path to the device under test is the lower impedance path can ensure that the analysis signal is directed through the DUT. For example, a controlled energy device may be provided to ensure that the path to the DUT is a low impedance path for efficient operation.

The device analysis signal generator may be provided in multiple different configurations. In a first configuration, a controlled energy device is arranged in series between the variable AC generator and the device under test. The device analysis signal generated by the variable AC generator can then be injected through the controlled energy device and into the device under test. In general, the controlled energy device can be provided using any controllable electrical device that can 1. store energy and 2. deliver and sink energy. For example, the controlled energy device can include one or more batteries, or DC/DC converters, or DC/AC Converters, or AC/AC converters, or motors or capacitors or inductors.

In the first configuration, at least one second secondary winding of the transformer can be disconnected. The at least one primary winding of the transformer can then operate as a blocking inductor to prevent unwanted AC signals from being injected into the device.

Operating in the first configuration may be desirable where the impedance of the current path to the device under test is much lower than the impedance of the current path to the power source/sink. For example, the first configuration can be used with a power supply operating in an output current control mode where the impedance analysis is being performed at low frequencies as this results in very efficient analysis signal injection.

In a second configuration, at least one second secondary winding of the transformer can be coupled to the variable AC generator. The variable AC generator then generates (or induces) one or more device analysis signals across the at least one primary winding. The device analysis signals can then be injected into the device (optionally superimposed over a DC current from the power supply). In the second configuration, the controlled energy device can be coupled to the device in parallel with the power source/sink. The controlled energy device can operate to decouple the power supply circuitry from the analysis signal generation circuitry.

Operating in the second configuration may be desirable for the injection of mid-frequency range analysis signals, particularly where the output impedance of the DUT is large at low frequencies.

In a third configuration, the controlled energy device may be omitted. For example, the controlled energy device may be omitted where the power source is operating as a high impedance power source (thereby ensuring that the path through the DUT is lower impedance) or where the DUT is being interrogated using high frequency analysis signals.

Optionally, the device analysis signal generator may be adjustable between a plurality of operating modes. For example, the device analysis signal generator may be adjustable between a first operational mode and a second operational mode. In the first operational mode, the device analysis signal generator can operate in the first configuration. In the second operational mode, the device analysis signal generator can operate in the second configuration.

Optionally, the device analysis signal generator may be further adjustable to a third operational mode. In the third operational mode, the device analysis signal generator can operate in the third configuration.

Optionally, the same controlled energy device may be arranged to be coupled to the device under test in parallel with the power source/sink in the second operational mode and arranged in series between the variable AC generator and the device under test in the first mode. This can provide a simple circuit topology that enables a wide range of frequencies AC signals to be injected into the device efficiently.

The device analysis signal generator, which is provided herein, overcomes a number of the deficiencies inherent in conventional industrial impedance spectroscopy systems. In particular, as the signal generator does not rely on the main power converter's (SMPS) switching devices to vary the frequency of AC signals injected into the device under test, the signal generator is configured to generate high frequency signals without being capped at the Nyquist rate (e.g., the signal generator is not limited to an effective bandwidth of one-tenth of the Nyquist rate of the main power converter). Further, as the signal generator does not rely on varying the switching frequency of the DC power source or sink to vary the frequency of the AC signal, the signal generator can also be configurable, to vary the amplitude, phase and frequency components of the AC signal. Still further, the signal generator may achieve high frequency AC outputs with minimal to no power loss (e.g., switching loss).

The signal generator is also configurable to de-couple the inverse correlation which exists in conventional industrial spectroscopy systems (such as power sources or sinks performing impedance spectroscopy) as between the power demand of a device under test and the maximum switching frequency of the spectroscopy system (e.g., the signal generator is able to produce high frequency AC signals independent of the power demand of the device under test). In this manner, the signal generator is configured for use in broadband impedance spectroscopy in order to generate high resolution impedance data over an extended frequency range. The signal generator is also configured for use both while under load (experiencing DC current and voltage) and while operating under no load conditions (eg; with an open-circuit voltage). This may allow for assessing a wide range of physical phenomena of a device (e.g., electrical, chemical, physical, and biological properties) that occur over short or long time scales and are determined when the device is perturbed using a wide range of frequency signals.

The device analysis signal generator can be provided in a portable analysis device. The portable analysis device can be connected to device(s) under test (sources and/or loads) to inject a device analysis signal and determine the impedance response. The portable analysis device may facilitate the assessment of a device under test in an installed position, which can be useful for quality testing, maintenance and repair applications for example.

The portable analysis device can include both electrical connectors to inject the device analysis signal into the device(s) to be interrogated as well as a data connection to couple to measurement devices associated with the device(s). The measurement devices may be positioned in close proximity to the device(s), to reduce the length of the sensing circuitry and thereby improve the resolution of the response data. In some cases, the measurement devices can remain installed with the devices while providing a detachable connection to the portable analysis device to allow for testing of the impedance response as required.

The data coupling between the portable analysis device and the measurement device(s) (and the electrical coupling providing the device analysis signal) can extend over a longer distance, to facilitate analysis of devices that are not easily accessible and/or while the devices remain in an installed condition. The portable analysis device can also transmit synchronization data (e.g. a sync signal or clock signal) to the measurement device(s) to ensure that the response data measured by the measurement device(s) can be correlated to the device analysis signal(s) that are injected.

A switch network may also be interposed between the analysis device and the measurement device(s). The switch network may enable the analysis device to selectively assess the impedance response of a large number of loads/sources through a single data cable, by selectively connecting the data cable to the corresponding measurement device(s). This may be particularly helpful where the system or device under test includes a large number of different sources or loads to be tested, such as a large number of individual components (e.g. battery cells) within a larger device under test (e.g. a battery stack) for example. The switch network may also remain installed with the device under test and measurement devices to provide a simple interface for a portable analysis device to assess the impedance response of the devices.

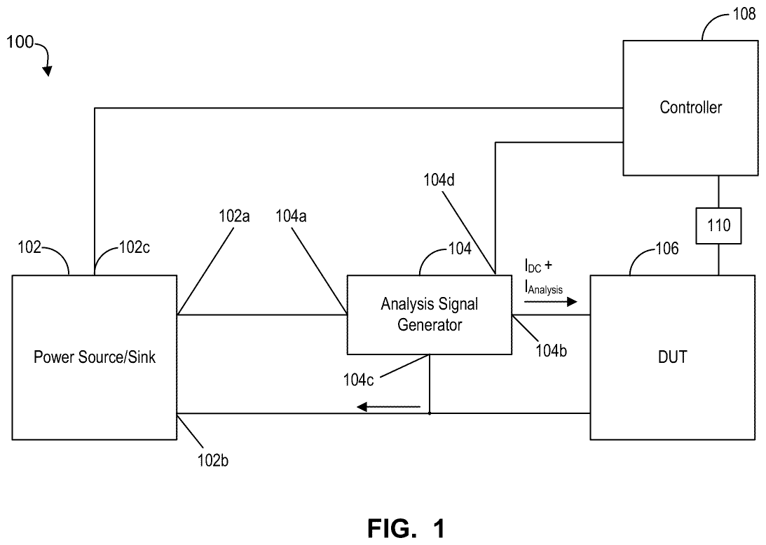

Referring now to FIG. 1, there is shown a simplified block diagram for an example impedance determining system 100. In the example illustrated, the system 100 includes a power source/sink 102, an analysis signal generator 104, a device under test 106 and a controller 108.

The power source/sink 102 may include any suitable power supply (e.g., a DC voltage/current source) that is configured to supply DC current (I_{DC}) in order to power a load when the device under test 106 includes a load. The power source/sink 102 may be provided using various types of power supplies such as DC/AC or AC/DC converters, one or more batteries, one or more fuel cells, one or more flywheels, one or more motors etc. The power supply may also include a power converter which converts unregulated AC or DC input voltage (e.g., from a voltage source, or power grid) to a regulated DC voltage output based on the power demands of the load. For example, the power supply may include a switch-mode power supply (SMPS) which uses a buck, boost, or a buck and boost circuit topology (e.g., a galvanically isolated or non-isolated circuit topology) to generate a regulated DC voltage or current output.

As shown in FIG. 1, the power supply can output a DC current at 102a that is provided as an input to the signal analysis generator 104 at 104a.

Optionally, the power source/sink 102 may omit a power supply. For example, where the device under test is a source (e.g. a fuel cell system or a battery system that is discharging), the power source/sink 102 may be provided as a power sink to dissipate the energy from the device under test. The power sink may be provided as a passive sink load (e.g. a resistor or inductor) or an active sink load (e.g. a controlled or uncontrolled electronic sink).

Optionally, the power source/sink 102 may include both a power supply and a power sink. For example, the power source/sink 102 may be a bidirectional power supply. The bidirectional power supply can be operable to supply a DC current (I_{DC}) in order to power the device under test 106 when the device under test 106 is a load. The bidirectional power supply can also operate as a power sink to dissipate energy from the device under test 106 when the device under test is a power source.

Optionally, the power source/sink 102 may be omitted. For example, the analysis signal generator 104 may be operable to interrogate a DUT 106 using an AC analysis signal alone (e.g. where the DUT has low impedance when unbiased).

The analysis signal generator 104 is coupled in series between the power source/sink 102 and the device under test 106. As explained in further detail herein, the signal generator 104 is configured to generate a time-varying signal (also referred to herein as an “analysis signal” (I_{Analysis}))) which can be injected into the device under test 106. For example, where the device under test 106 is a load or source, the analysis signal can be superimposed over the DC current (I_{DC}) and the combined AC and DC signals (I_{DC}+I_{Analysis}) can output at 104b and injected into the load.

The signal generator 104 may be configured to generate different analysis signals which oscillate at different frequencies. For example, where the system 100 is used in impedance spectroscopy, the signal generator 104 may inject the device under test 106 with various frequency analysis signals, and may determine the impedance response of the device under test 106 at each applied frequency.

The signal generator 104 may also be configured to generate analysis signals within a wide frequency range (e.g., extending up to a megahertz (MHz) range) to provide for high resolution impedance spectrum data. Alternatively or in addition, rather than generating multiple analysis signals, the signal generator 104 may be configured to generate a single analysis signal having multiple frequency components (also known as a mixed-frequency signal, or a multi-sine signal or pulses). The impedance response of the device under test 106 may then be determined in relation to each applied frequency component.

The device under test 106 is any suitable physical load and/or source which is the subject of impedance measurements. For example, where the system 100 is applied in electrochemical impedance spectroscopy (EIS), the device under test 106 may be a battery, a fuel cell, or an electrolyzer. The device under test 106 may be a load (e.g. an electrolyzer or battery being charged) or a source (e.g. a fuel cell or battery being discharged).

The device under test 106 may also be a membrane which is employed in membrane-based wastewater treatment (e.g., a reverse-osmosis (RO) membrane). Alternatively, the device under test 106 may be an electroflotation, electrocoagulation, electrooxidation and/or electrocoagulation water treatment cell. Optionally, the device under test 106 may be coupled to the system 100 using one or more electrodes. For instance, the device under test 106 may be positioned between two electrodes configured to couple the device under test 106 to power source/sink 102 and the AC voltage (i.e., generated by analysis generator 106). Although only a single device under test 106 is shown in FIG. 1, it should be understood that multiple components of a device under test 106 may be interrogated (e.g. multiple cells within a stack of device under test).

One or more sensors 110 may couple to the device under test 106. The sensors 110 may provide data and/or information to the controller 108 for use in determining the impedance response of the device under test 106 to various frequency analysis signals (or analysis signals which include different frequency components). The sensors 110 may include one or more sensors operable to measure the AC and/or DC voltage across the device under test 106 and/or the AC and/or DC current through the device under test 106.

For example, the sensor 110 may be a voltage or current sensor that is configured to measure the AC voltage differential across the device under test 106 or the AC current through the device under test 106. For example, the voltage differential, in conjunction with a known value and frequency for the analysis signal (I_{Analysis}), may be used by the controller 108 to determine the impedance response of the device under test in accordance with Equation (1).

Optionally, the sensors 110 may be detachably attachable to the device under test 106. This can allow the sensors 110 to be used to determine the impedance response of different devices under test 106.

Alternatively or in addition, the sensors 110 may be retained in place and connected to the corresponding device under test 106. For example, a given sensor 110 may remain installed along with the corresponding component of the device under test 106. This may simplify analysis of a device under test 106 while they remain in an installed configuration (e.g. individual battery elements within a battery stack of a system such as an electric vehicle).

Controller 108 may be provided for controlling the various components of the system 100. For example, the controller 108 may couple to the analysis signal generator 104 (see 104d). The controller 108 may then control the frequencies and/or amplitudes of the analysis signals generated by the signal generator 104. For example, the controller 108 may direct the signal generator 104 to generate a pre-determined number of analysis signals having pre-determined frequencies within a pre-determined frequency range. Alternatively or in addition, the controller 108 may direct the signal generator 104 to generate a single analysis signal having a pre-determined number of frequency components. The controller 108 may also control the time span of each analysis signal, as well as the time-interval between consecutive analysis signals.

The controller 108 may also be configured to determine an optimal analysis signal for a given device under test 106 and/or application. For example, the controller 108 may determine an optimal analysis signal based on requirements or constraints defined for a particular application (e.g. parameters defined by an operator of the controller 108) such as time requirements and/or electrical efficiency requirements.

The controller 108 may further couple to the sensor 110. The controller 108 may receive data measurements (e.g., voltage and current measurements) from the sensor(s) 110, and may use the data measurements to determine the impedance response of the device under test 106. The controller 108 may also be used to further generate an impedance spectrum of the device under test 106 based on the impedance response at different applied frequencies.

The controller 108 may also couple to the power source/sink 102. For example, where the power source/sink 102 includes a power converter with a switching device, the controller 108 may adjust the switching frequency of the switching device to adjust the AC ripple frequency generated by the power converter (e.g., to minimize the AC ripple). Alternatively or in addition, the controller 108 may adjust the duty cycle of the power converter (and optionally, the switching frequency) to vary the regulated DC output generated by the power converter in order to accommodate for the varying power demands of the device under test 106. Alternatively or in addition, the controller 108 may adjust an operational mode of the power source/sink 102 between a power supply operational mode (e.g. usable to interrogate one or more loads) and a power sink operational mode (e.g. usable to interrogate one or more sources).

The controller 108 may also couple to one or more additional sensors which are configured to measure either the DC current (I_{DC}) flowing across the signal generator 104, or other parameters which relate to the DC current (I_{DC}).

In various embodiments, the controller may be integrated with the signal generator 104.

Optionally, the signal generator 104 may be operable in multiple different operational modes. The controller 108 may couple to the signal generator 104 to control and/or adjust the operational modes of the signal generator.

Optionally, the signal generator 104 may be detachably attachable to a given device under test 106 to interrogate the corresponding device under test 106. Controller 108 may be detachably attachable to each sensor 110 to determine the impedance response of the corresponding device under test 106. For example, the signal generator 104 and controller 108 may be provided in a portable analysis device that can be used to evaluate one or more loads or sources that are contained within one or more devices under test 106. This may simplify the process for measuring the impedance of loads or sources that are not easy to access e.g. installed within other devices or systems.

Optionally, a portable analysis device may also include the power source/sink 102. This may simplify the process of interrogating a device under test, by making an external power supply/sink unnecessary. Alternatively, the power source/sink 102 may be separate from the portable analysis device. Further alternatively, a separate power source/sink 102 may be omitted.

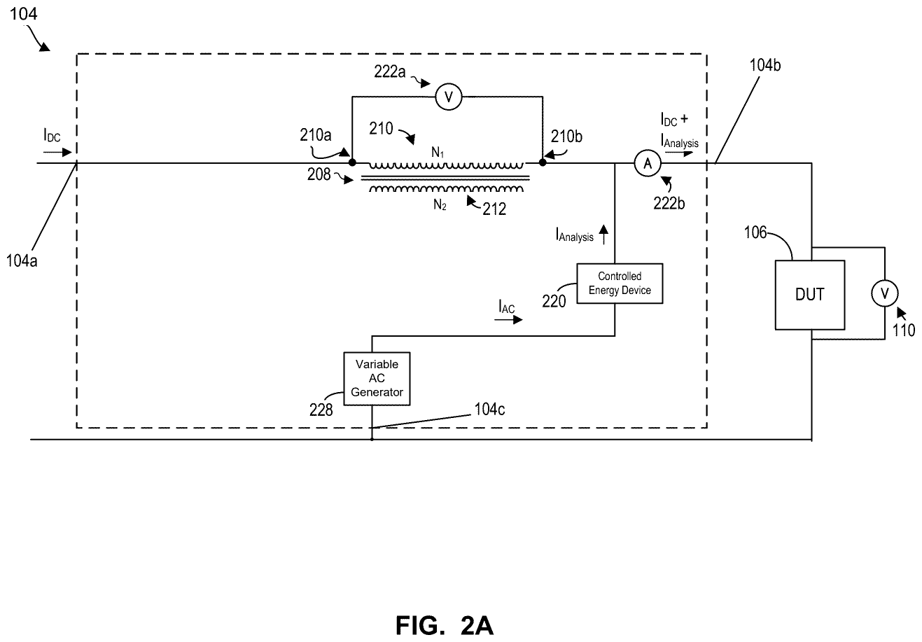

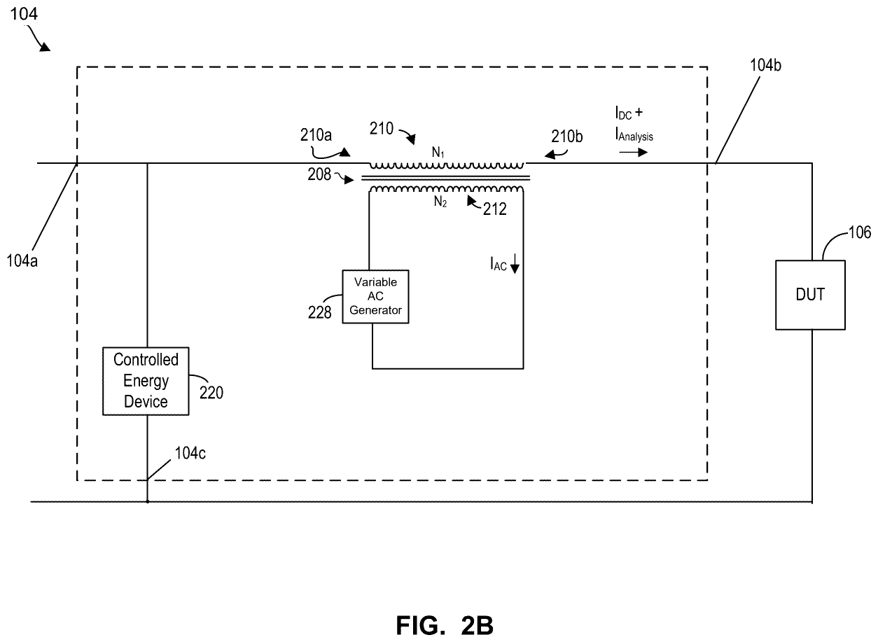

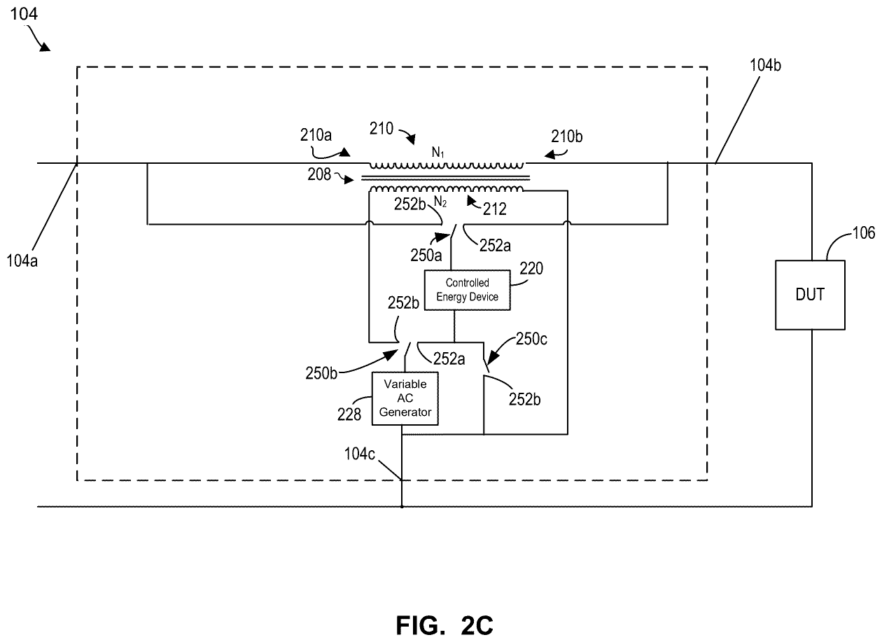

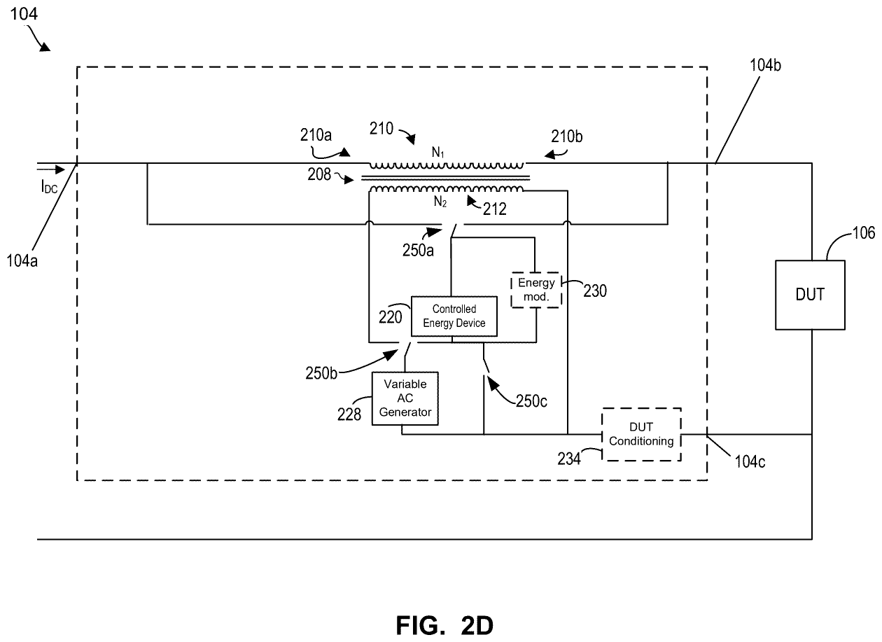

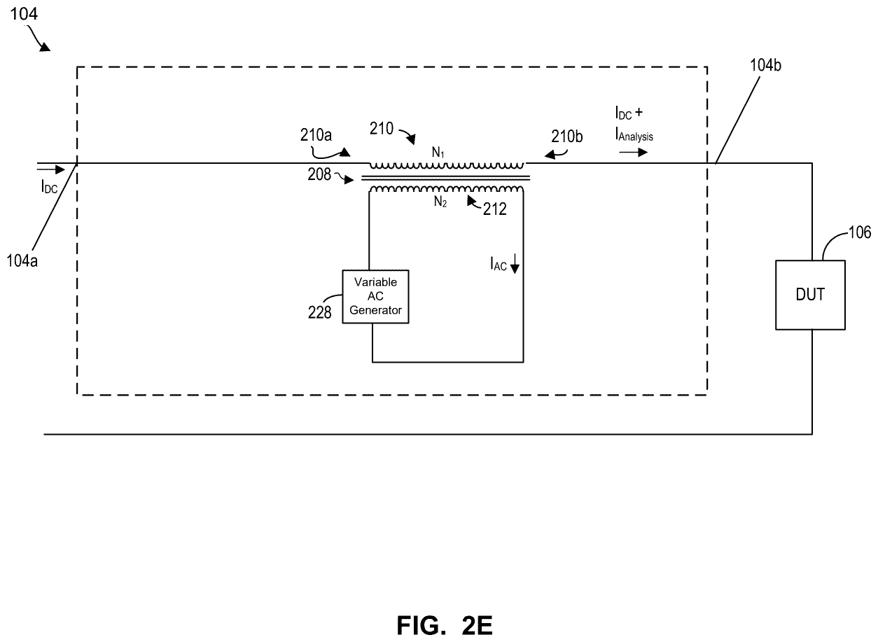

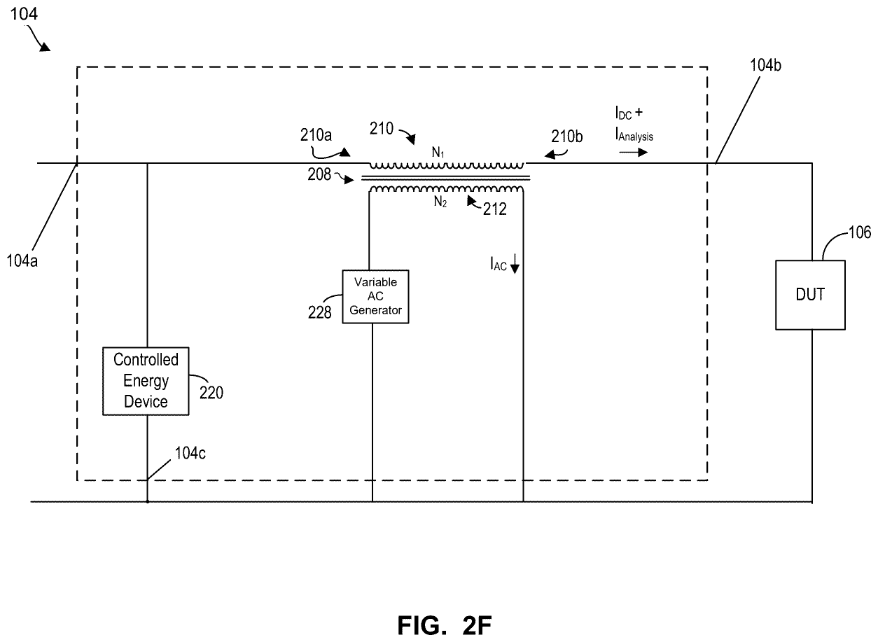

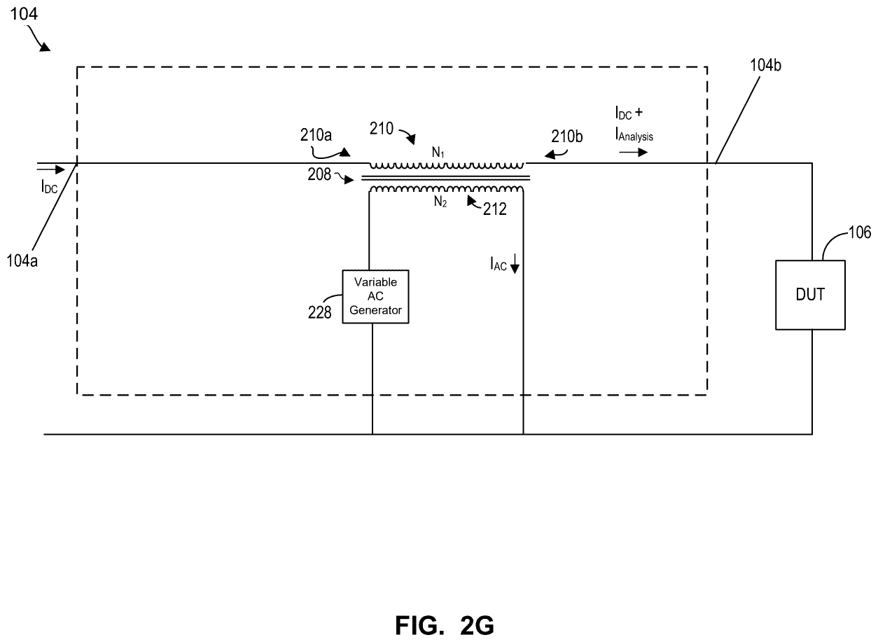

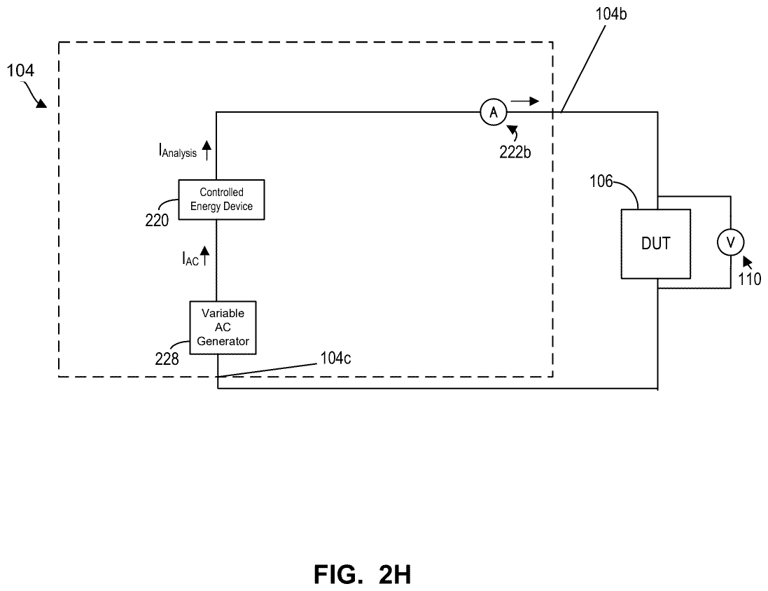

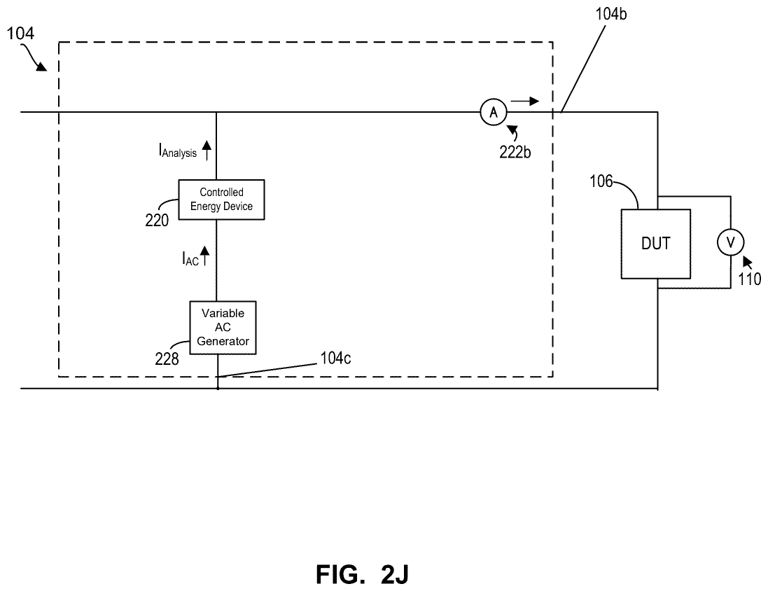

Referring now to FIG. 2A, there is shown a simplified circuit diagram of an example signal analysis generator 104 that may be used with the impedance determining system 100 of FIG. 1.

As shown in FIG. 2A, the power source/sink 102 can be configured to generate a near steady-state DC current output (I_{DC}), which in some cases, may include a small AC switching ripple. The DC current (I_{DC}) can be fed to the analysis signal generator 104 at 104a.

In the example illustrated, the analysis signal generator 104 is formed from a multi-winding transformer 208 which includes at least one primary-side winding 210 having N, winding turns, and at least one secondary winding. In the illustrated example, the at least one secondary winding includes a single secondary-side winding 212 having N₂ turns. Alternatively, the at least one secondary winding may include multiple secondary windings, for example a first secondary-side winding 212 and a second secondary-side winding (not shown). Further alternatively or in addition, the at least one primary-side winding may include multiple primary windings, for example, a first primary-side winding and a second primary-side winding (not shown).

The primary winding 210 is coupled in series between the power source/sink 102 and the device under test 106. The primary winding 210 includes an input node 210a coupled to the output of the power source/sink 102, and an output node 210b coupled to the device under test 106. DC current (I_{DC}), from the DC power supply 102 can accordingly flow across the primary winding 210 to power a load when the device under test 106 includes one or more loads. Alternatively, DC current (I_{DC}) can flow from the DUT to the sink 102 (e.g. where the device under test is a power source).

The generator 104 also includes a variable AC signal generator 228 (also referred to herein as an analysis signal source 228). The analysis signal source 228 is configured to generate a time-varying AC signal (IAC) that can be applied to the device under test 106 to assess its impedance response.

As shown in FIG. 2A, a controlled energy device 220 is coupled in series between the variable AC generator 228 and the device under test 106. The AC signal (IAC) flows through a controlled energy device 220 and in turn, generates the analysis signal (I_{Analysis}). The controlled energy device 220 can provide AC signal coupling in the configuration shown in FIG. 2A.

As can be seen from FIG. 1 and FIG. 2A, the DUT 106 and power source/sink 102 are arranged in parallel with respect to the variable AC generator 228 (and the controlled energy device 220). Accordingly, the generator 104 can be configured to ensure that the current path to the DUT (i.e. through 104b) is lower impedance than the current path through the power supply/sink (i.e. through 104a). The controlled energy device 220 can be operated to direct current from the variable AC generator 228 to the DUT 106. In the example shown in FIG. 2A, the transformer 210 can also operate as a blocking inductor to increase the impedance of the current path to the power supply/sink seen by the AC signal (I_{Analysis}).

In the example shown, the analysis signal (I_{Analysis}) can be equal to the AC signal (IAC) generated by the AC generator 228 in both frequency and amplitude. Where the device under test 106 includes a load, the analysis signal (I_{Analysis}) can be superimposed over the DC current (I_{DC}) from the power supply having passed through the primary winding 210 to generate a combined AC and DC signal (i.e., I_{DC}+I_{Analysis}) that can be injected into a load at 104b.

Alternatively, the DC current (I_{DC}) from the power supply may be zero and/or a power supply may be omitted. In such cases, the AC signal (I_{Analysis}) may be the only signal injected into the DUT at 104b.

The controlled energy device 220 can be provided using any controllable electrical device that can (i) store energy and (ii) deliver and sink energy. For example, the controlled energy device 220 can include one or more batteries, or DC/DC converters, or DC/AC Converters, or AC/AC converters, or motors or capacitors or inductors for example.

The variable AC generator 228 may be configured to generate analysis signals at variable frequencies, phases and/or amplitudes. For example, where the system 100 is used in impedance spectroscopy, the AC generator 228 may generate a plurality of analysis signals, each having different frequencies. The analysis signals may be then separately injected into the device under test 106, and the impedance response of the device under test, at each frequency, may be individually determined, i.e., to generate an impedance spectrum. Alternatively or in addition, the variable AC generator 228 may generate a single analysis signal having multiple frequency components.

The AC generator 228 may generate analysis signals at high frequency ranges (or having high frequency components) which, in turn, allows for the impedance response of the device under test 106 to be determined over a wide frequency range. In particular, this allows for assessing electrical, chemical, biological and physical properties of the device under test 106 that are only determined when the device is perturbed using high frequency signals (e.g., including membrane properties, and bulk and surface resistance).

As previously mentioned, the maximum frequency output of the AC signal generator 228 is not otherwise capped by the Nyquist rate of the DC power source/sink 102. Additionally, the AC generator 228 may generate high frequency analysis signals without suffering from consequent power loss (e.g., switching loses), which may otherwise hamper the performance of conventional industrial impedance spectroscopy systems. Accordingly, the AC generator 228 is able to effectively generate high resolution impedance spectroscopy data over large frequency bandwidths.

The AC generator 228 can also be configured to operate at an arbitrarily large current & voltage for the DUT without sacrificing efficiency or space.

The AC generator 228 can also generate analysis signals at low frequency ranges (or having low frequency components). By coupling the AC generator 228 to the device under test 106 the low frequency analysis signals can be injected directly into the device under test 106. The controlled energy device 220 can operate to eliminate any offsets generated by the AC generator 228 that may otherwise interfere with or obscure the impedance response of the device under test 106.

The AC generator 228 may further couple to the controller 108. The controller 108 may control the frequencies of the analysis signals generated by the AC generator 228. For example, the controller 108 may control the AC generator 228 to generate a pre-determined number of discrete analysis signals at pre-determined frequencies within a pre-determined frequency range. The impedance response of the device under test 106 may then be separately determined at each applied frequency. The controller 108 may also specify the time-interval between when consecutive analysis signals are generated and injected into the device under test 106. Accordingly, this may allow sufficient time for injecting each analysis signal into the device under test 106, and calculating the resultant impedance response of the load or source. In still other cases, rather than generating multiple AC signals at multiple frequencies, the controller 108 may direct the AC signal generator 228 to generate a single mixed-frequency AC signal having a range of low and high frequency components.

Alternatively, the AC generator 228 may not be coupled to the controller 108, and may be pre-configured to automatically generate various analysis signals at pre-determined frequencies and at pre-determined time intervals. Additionally, or in the alternative, the AC generator 228 may also be pre-configured to generate one or more analysis signals with multiple pre-determined frequency components.

In order to determine the impedance response of the device under test at different applied frequencies of analysis signals (or analysis signals with different frequency components), the controller 108 may couple to the sensor 110 and receive data therefrom. In the example illustrated, the sensor 110 is a voltage sensor which is connected in parallel arrangement to the device under test 106. Alternatively or in addition, the sensors can be configured to measure AC current through the device under test 106. As noted above, the sensors 110 can also include sensors operable to measure DC current and/or voltage.

The voltage sensor measures the differential AC voltage across the device under test 106 in response to an applied analysis signal, and transmits the voltage reading to the controller 108. The controller 108 may then determine the impedance response of the device under test using the voltage reading, as well as known information regarding the magnitude and frequency of the injected analysis signal (I_{Analysis}) (e.g., in accordance with Equation (1)).

The injected analysis signal (I_{Analysis}) can be applied to the device under test 106 using either current injection (as described herein above) or voltage analysis in which the sensors 110 measure the AC current response to the applied voltage. In either case, the impedance response of the device under test can be determined using the sensor data in combination with known information regarding the injected analysis signal (I_{Analysis}).

Where the device under test 106 is injected with a single analysis signal having several frequency components, the controller 108 may be configured to de-compose the AC voltage reading—received from the voltage sensor 110—into its various frequency components using any appropriate spectral and/or frequency decomposition method (e.g., a Fast Fourier Transform (FFT), a Discrete Fourier Transform (DFT) or other non-linear transforms or linear transforms). The controller 108 may then separately analyze the impedance response of the device under test to each applied frequency component.

Various additional sensors 222 may also be coupled to the controller 108 to measure the current and voltage through different portions of the generator 104. For example, the sensors 222 may be coupled to the controller 108 for use in determining the DC current (I_{DC}) flowing through various portions of the signal generator 104, e.g. across the primary winding 210, secondary winding 212 (e.g. in the configuration shown in FIG. 2B), through the variable AC generator, through the controlled energy device 220 etc. In the illustrated example, the controller 108 may couple to a voltage sensor 222a connected in parallel to the primary winding 210 (i.e., between the input node 210a and the output node 210b). The voltage sensor 222a may measures the differential DC voltage across the primary winding 210 and may transmit the measured voltage reading to the controller 108. The controller 108 may then determine the DC current (I_{DC}) flowing across the primary winding 210 based on the voltage reading and a known impedance of the primary winding 210.

Alternatively or in addition, the controller 108 may couple to a current sensor usable to measure the current through different portions of the signal generator 104. For example, the current sensor 222b which is in series connection between the output node 210b, of the primary winding 210, and the device under test 106. The current sensor 222b may directly measure the DC current (I_{DC}) flowing across the primary winding 210 and may transmit this information to the controller 108. Accordingly, the controller 108 may determine the DC current (I_{DC}) across the primary winding directly from the data received from the current sensor 222b. Alternatively, the current sensor 222b may also be positioned between the DC power source/sink 102 and the input node 210a (of the primary winding), as well as after the device under test 106. In various cases, the current sensor 222b may also measure AC current (e.g., I_{Analysis}), and also transmit this measurement information to the controller 108.

The sensors 222 may be configured to transmit information on a continuous basis, or periodically at pre-defined time intervals, to the controller 108. Alternatively or in addition, the sensors may transmit readings in response to the occurrence of certain events. For example, the sensors may transmit readings only when a change (or a significant change) is detected in a monitored parameter. Alternatively or in addition, the sensors may transmit information at the request of the controller 108.

It will be appreciated that the sensor configuration illustrated in FIG. 2A has only been shown herein by way of example, and that other sensors and/or sensor configurations may be used for determining the current at various points in the system 100. For example, various sensor configurations may be used for determining the DC current (I_{DC}) flowing through the generator 104 (e.g. at input 104a, across the controlled energy device 220, across the variable generator 228, at the output 104b, at 104c, across the primary winding, across the secondary winding etc.) and other portions of system 100. Furthermore, it should be appreciated that various other sensors and/or sensor configurations may be used for determining the AC current flowing through different portions of the signal generator 104, such as current flowing through the controlled energy device 220, the current output from the variable AC generator 228, AC current flowing through the generator 104 (e.g. at input 104a, across the controlled energy device 220, across the variable generator 228, at the output 104b, at 104c, across the primary winding, across the secondary winding etc.) and other portions of system 100.

In the example shown in FIG. 2A, the at least one secondary winding can be disconnected. The primary winding 210 can thus operate as a blocking inductor to minimize or prevent unwanted AC signal components from the power source/sink 102 from being transmitted to the device under test 106. This may also increase the impedance of the current path to 104a seen by the AC signal from the variable AC generator 228.

Referring now to FIG. 2B, there is shown a simplified circuit diagram of another example load signal analysis generator 104. In the example shown in FIG. 2B, the secondary winding 212 is coupled in series to the variable AC signal generator 228. The analysis signal source 228 is configured to generate a time-varying AC signal (I_{AC}) across the secondary winding 212. The AC signal (I_{AC}) flows across the secondary winding 212, and in turn, generates the analysis signal (I_{Analysis}) across the primary winding 210.

In the example shown in FIG. 2B, the analysis signal is equal in frequency to the AC signal (I_{AC}), and is otherwise related to the AC signal in accordance with Equation (2):

$${I}_{Analysis} = \frac{{N}_{2}}{{N}_{1}} {I}_{A C} \qquad ( 2 )$$

Where the device under test 106 includes one or more loads, the analysis signal (I_{Analysis}) can be superimposed over the DC current (I_{DC}) in the primary winding 210 to generate a combined AC and DC signal (i.e., I_{DC}+I_{Analysis}) that is injected into the load at 104b. Alternatively, the DC current may be zero and/or the power supply/sink 102 may be omitted.

As shown in FIG. 2B, a controlled energy device 220 is coupled to the device under test 106 in parallel with the power supply/sink 102. The controlled energy device 220 can decouple the AC signal generator circuitry from the power supply circuitry to reduce the impact of noise on the signal being injected into the device under test 106. The controlled energy device 220 can also increase the efficiency of the analysis signal injection into the DUT 106.

Optionally, the analysis signal generator may be adjustable between a plurality of operational modes. The plurality of operational modes may include a first operational mode (e.g. the configuration shown in FIG. 2A) and a second operational mode (e.g. the configuration shown in FIG. 2B). The analysis signal generator may be adjusted between the operational modes to provide a desired operating configuration for a given application or a given device under test 106.

Optionally, the same controlled energy device 220 can provide a decoupling function in the second operational mode and provide AC signal coupling in the first operational mode.

Optionally, the analysis signal generator may be further adjustable to a third operational mode (e.g. the configuration shown in FIG. 2E). In the third operational mode, the controlled energy device 220 may be omitted from the signal generation circuitry.

The operational mode of the analysis signal generator may be selected based on various operational parameters, such as the presence/absence and/or operating mode of the power source/sink 102 and/or the value of the DUT impedance being measured. For example, where the power source/sink 102 is operating in an output voltage control mode, then the second operational mode may allow for mid to high frequency injections. Alternatively, where the power source/sink 102 is operating in an output current control mode then the first operational mode may be preferred.

Optionally, the analysis signal generator may include an internal switch network. The internal switch network may be controllable to adjust the operational mode of the analysis signal generator. The internal switch network may be adjustable between a plurality of switch positions, with each switch position corresponding to a different operational mode. For example, the internal switch network may be adjustable between a first switch position in which the analysis signal generator is configured to operate in the first operational mode and a second switch position in which the analysis signal generator is configured to operate in the second operational mode.

Referring now to FIG. 2C, shown therein is a simplified circuit diagram of an analysis signal generator that includes an example internal switch network 250a-250c. The internal switch network 250a-250c shown in FIG. 2C is an example of a switch network that may be used to adjust the generator 104 between first and second operational modes. It will be appreciated that other circuit configurations and/or switch network configurations may be provided to adjust the operational mode of the analysis signal generator.

As shown in the example of FIG. 2C, the internal switch network 250a-250c can include a plurality of switches 250. Each switch 250 is adjustable between a first position (indicated by 252a apart from switch 250c which is open in the first position) and a second position (indicated by 252b). When switches 250 are adjusted to the first position 252a, the generator 104 is connected in a first operational mode corresponding to the configuration illustrated by FIG. 2A. In this configuration, the variable AC generator 228 is coupled to the device under test 106 through the controlled energy device 220.

When the switches 250 are adjusted to the second position, the generator 104 is connected in a second operational mode corresponding to the configuration illustrated by FIG. 2B. In this configuration, the variable AC generator 228 is coupled to the device under test 106 through transformer 110 while the controlled energy device 220 is arranged in parallel with the power supply/sink.

The controller 108 may couple to the switch network 250a-250c to control the position of the switches 250 and thereby control the operational mode of the generator 104. The controller 108 may adjust the operational mode of the generator 104 based on various operational parameters, such as the operating mode of the power source/sink 102 and/or the value of the DUT impedance being measured.

Referring now to FIG. 2D, shown therein is a further example of an analysis signal generator 104. The example analysis signal generator shown in FIG. 2D is generally similar to generator 104 shown in FIG. 2C except for the addition of various circuit protection components 230 and 234 for protection and/or improved efficiency.

As shown in FIG. 2D, the signal generator 104 can optionally include protection circuitry that includes an energy modulator 230. The energy modulator circuitry 230 can be configured to ensure the safe operation of the generator 104. For example, the energy modulator 230 may be operable to detect an overvoltage condition and redirect current to prevent damage to the device under test 106 and other operational components of the generator 104. The energy modulator 230 can include both active and passive circuitry and can include sensors (e.g. DC and AC current and voltage sensors) operable to detect the current operating conditions of the generator 104.

The signal generator 104 can also include a DUT conditioning component 234 operable to ensure safe operation of the device under test during interrogation. For example, the DUT conditioning component 234 can be configured to limit the peak current through the device under test 106 during turn-on of the generator 104 and/or interrogation of the device under test 106 more generally. Optionally, the DUT conditioning component 234 may be implemented using passive circuitry (e.g. a resistor selected to inhibit high current level) and or active circuitry. Operation of the DUT conditioning component 234 can be controlled using controller 108.

It will be appreciated that the circuit protect configuration illustrated in FIG. 2D has only been shown herein by way of example, and that other circuit protection elements and configurations may be used to protect against damage due to undesirable operating conditions such as high current and/or high voltage conditions. For instance, circuit protection components may be arranged at different locations of the signal generator 104 (e.g. a DUT conditioning component arranged upstream from the output 104b). Furthermore, it should be understood that the example circuit protect configuration illustrated in FIG. 2D is optional and some or all of the circuit protection elements may be omitted in different implementations.

Referring now to FIG. 2E, there is shown a simplified circuit diagram of another example signal analysis generator 104. FIG. 2E illustrates an example of a third configuration of the signal analysis generator 104.

The example analysis signal generator shown in FIG. 2E is generally similar to generator 104 shown in FIG. 2B except that the controlled energy device 220 has been omitted. The omission of the controlled energy device 220 enables the generator 104 to operate without limitations on the voltage or the current through the system.

The example signal analysis generator configuration shown in FIG. 2E may provide a simple operating configuration for certain operational use cases. For example, where the signal generator 104 is coupled to a high impedance power supply/sink and/or the signal generator is being operated to inject high frequency signals into the DUT 106 (such that the power supply/sink will be high impedance), then the AC signals from the variable signal generator 228 can be routed to the DUT 106 directly.

Referring now to FIG. 2F, there is shown a simplified circuit diagram of another example signal analysis generator 104. The example analysis signal generator shown in FIG. 2F is generally similar to generator 104 shown in FIG. 2B except that the variable AC generator 228 is electrically connected to the DUT. The fourth operational mode shown in FIG. 2F may be used in place of the second operational mode, for example, where full galvanic isolation is not required or when common mode currents are not a concern.

Referring now to FIG. 2G, there is shown a simplified circuit diagram of another example signal analysis generator 104. The example analysis signal generator shown in FIG. 2G is generally similar to generator 104 shown in FIG. 2E except that the variable AC generator 228 is electrically connected to the DUT. The fifth operational mode shown in FIG. 2G may be used in place of the third operational mode, for example, where full galvanic isolation is not required or when common mode currents are not a concern.

Referring now to FIG. 2H, there is shown a simplified circuit diagram of another example signal analysis generator 104. As noted above, the power source/sink 102 FIG. 1) may be omitted and the AC signal (I_{Analysis}) may be the only signal injected into the DUT at 104b. Transformer 210 is not required as there is no DC current (I_{DC}). In some embodiments, the AC signal (I_{Analysis}) may be generated directly by the variable AC generator 228 and the controlled energy device 220 may be omitted.

Referring now to FIG. 2J, there is shown a simplified circuit diagram of another example signal analysis generator 104. In this example, the signal analysis generator couples a power source/sink 102 (FIG. 1) to a device under test 106, but does not have a transformer 210. A DC current (I_{DC}) and the AC signal (I_{Analysis}) are coupled to the device under test. In some embodiments, the AC signal (I_{Analysis}) may be generated directly by the variable AC generator 228 and the controlled energy device 220 may be omitted.

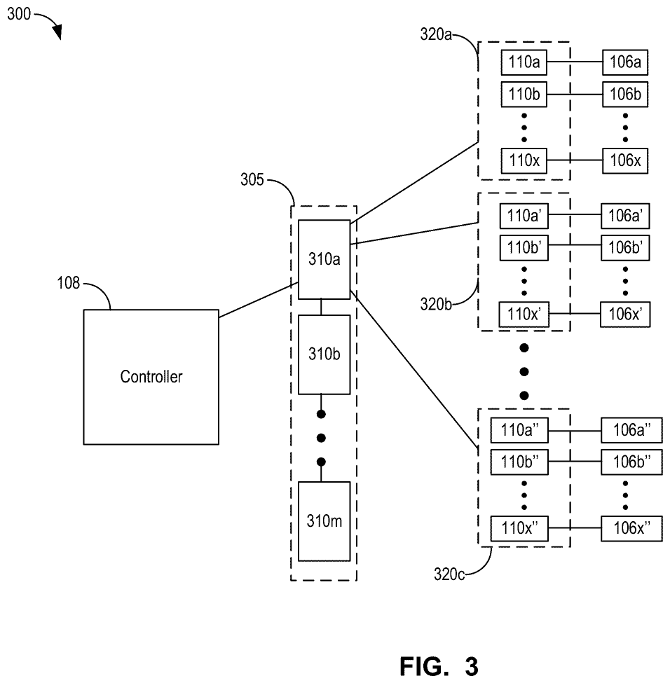

Referring now to FIG. 3, shown therein is an example system 300 for measuring impedance properties of a device under test including plurality of sources or loads 106. In FIG. 3, the generator 104 and power source/sink 102 have been omitted for ease of understanding. However, it should be understood that system 300 can include an analysis signal generator 104 and power source/sink 102 that are connectable to each of the sources/loads 106.

The system 300 can include a plurality of sensors 110a-110x″. Each sensor 110 can be operably connectable to a corresponding source or load 106 in the plurality of sources or loads 106a-106x″. Each sensor 110 can be configured to measure the differential AC voltage across the corresponding source or load 106 in response to an applied (voltage or current) analysis signal. For example, each first sensor 110 can include a first voltage sensor connectable in parallel arrangement to the corresponding source or load 106.

The controller 108 can be coupled to each sensor 110 to receive an input signal representative of the measured voltage data that is usable to determine the impedance response of the corresponding source/load 106. The controller 108 can be coupled to each sensor 110 through a data network (e.g. by one or more data cables). The controller 108 can transmit data (e.g. synchronization data) to, and receive data (e.g. input signal data) from each sensor 110 using the data cable(s). Optionally, the controller 108 may also provide power to each sensor 110 using the data cable, e.g. using a Power over Ethernet standard or other protocols.

As shown in FIG. 3, the sensors 110 can be provided by one or more measurement devices 320. Although three measurement devices 320a-320c are shown in FIG. 3, it should be understood that a greater or fewer number of measurement devices 320 may be used. Each measurement device 320 can include one or more corresponding sensors 110. Each sensor 110 in the measurement device 320 can be operably connectable to a different corresponding source or load 106. Optionally, the measurement device 320 can include one or more sensors for each source or load 106 operable to measure the AC and/or DC current and/or voltage for that source or load 106.

Typically, a measurement device 320 can include a plurality of sensors 110 as shown in FIG. 3. This can simplify the process of testing multiple sources or loads, by allowing the controller to be connected to a measurement device that in turn is able to measure response data from a plurality of sources or loads.

Optionally, the controller 108 can be connected directly to the measurement device 320. Alternatively, an external switch network 305 can be positioned or interposed between the controller 108 and the measurement devices 320. The external switch network 305 can be operated to selectively couple the controller 108 to a plurality of different sources/loads 106. This may allow a greater number of sources/loads 106 to be analyzed through a single connection to the controller 108. This can reduce the time and complexity required for testing of devices, particularly in installations that include a large number of sources/loads 106, where the sources/loads are not easily accessible or where the source/load has multiple components (e.g. multiple cells within a stack) some or all of which need to be interrogated individually. This can also allow the measurement devices 320 to be positioned in close proximity to the corresponding sources/loads 106 while still allowing for the controller 108 to be easily coupled to the measurement devices 320.

As shown in the example of system 300, the external switch network 305 can include a plurality of external switches 310a-310m. The switches can be connected to the controller 108 in a series with each external switch 310 coupled to at least one adjacent external switch 310 in the series. For example, the plurality of external switches 310 may be daisy-chained to the controller 108. This may simplify the connection between the controller 108 and the individual switches 310.

Alternatively, the external switch network 305 may have a different configuration (i.e. not requiring a daisy-chain operation). For example, the external switch network 305 may include various other configurations to enable the controller 108 to be selectively connected to a large number of measurement devices 320 using a low number of ports.

Optionally, the measurement device(s) 320 may remain fixed in place proximate the sources/loads 106. This can be useful where the sources/loads to be interrogated are installed or contained within portions of other systems or devices that are not easily accessible. By providing the measurement devices 320 close to the sources/loads 106 to be analyzed, the sensors 110 can be implemented using short sensing cables. This may reduce the impact of noise on the measurements obtained by sensor 110.

Optionally, the switch network 305 can also remain fixed in place to provide an easy connection to the measurement devices 320 and thereby sources/loads 106. This may simplify testing and maintenance of the sources/loads 106 by providing a more easily accessible connector to measure the impedance response of the sources/loads 106.

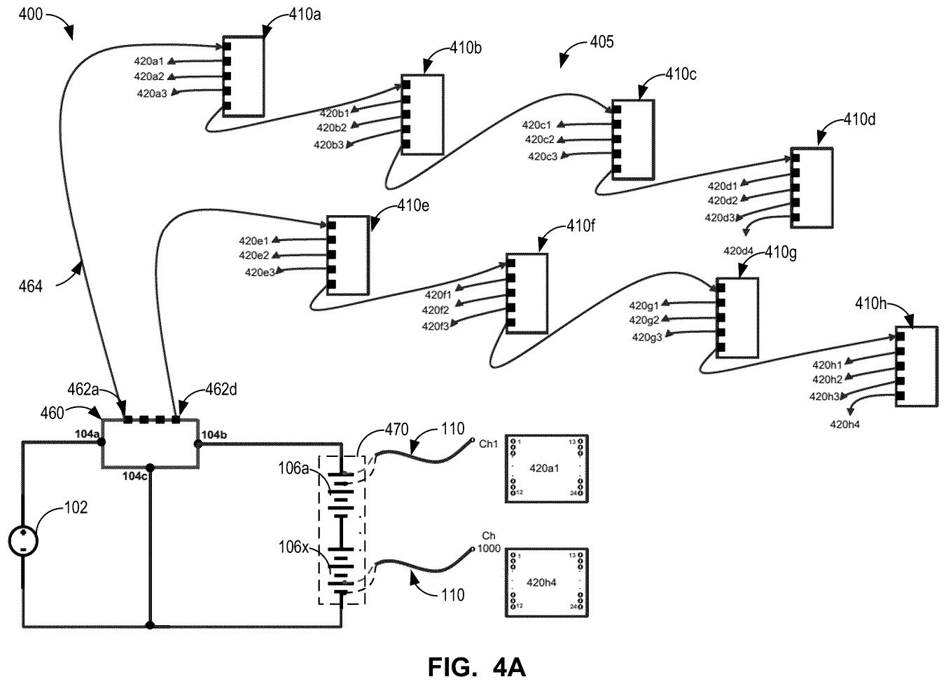

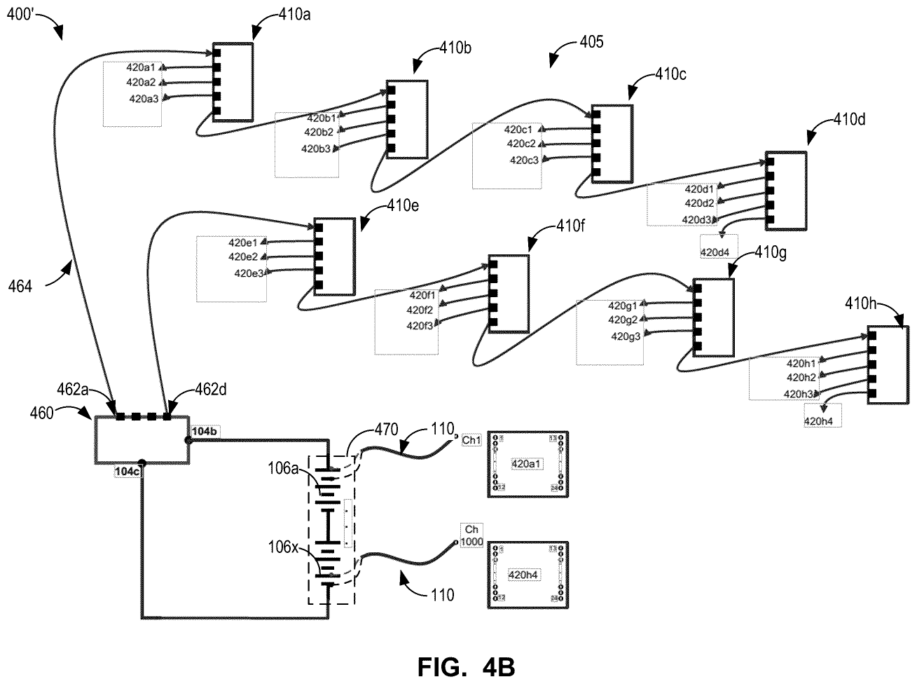

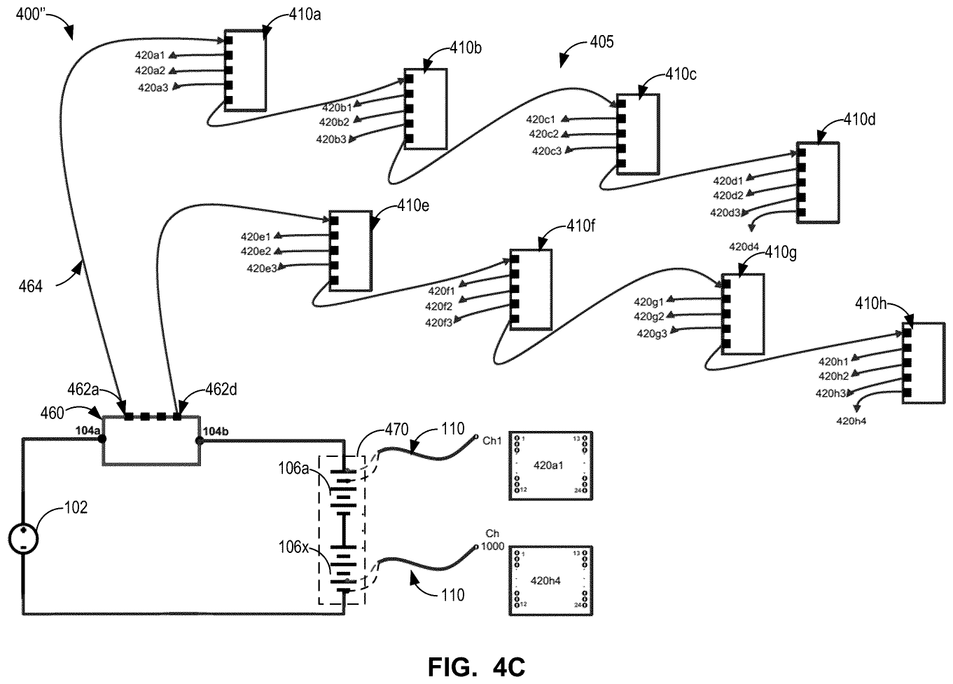

Referring now to FIG. 4A, shown therein is an example system 400 that includes a portable analysis device 460. The portable analysis device 460 can include the signal generator 104 (i.e. including the transformer 210, variable AC generator 228, controlled energy device 220 etc.) and controller 108.

As shown in system 400, the analysis device 460 can be connected to switch network in order to measure the impedance response of sources/loads 106a-106x of a device under test 470. In system 400, the analysis device 460 is connected to a first switch network (switches 410a-410d) and at least one additional switch network (switches 410e-410h). Each switch network includes a plurality of switches 410. Each switch 410 is in turn connected to a plurality of measurement devices 420 (e.g. 420a1-420a3, 420b1-420b3, 420c1-420c3, 420d1-420d4, 420e1-420e3, 420f1-420f3, 420g1-420g3, 420h1-420h3) and at least one adjacent switch 410 in the same switch network. As shown in FIG. 4A, the plurality of switches 410 can be connected to the analysis device 460 in a daisy-chain arrangement although it will be appreciated that other wiring configurations can also be used for the switch network.

As shown in FIG. 4A, each measurement device 420 can be provided with a plurality of measurement channels (e.g. 24 channels in the example illustrated). Each channel can be coupled to a corresponding sensor that measures the response of a given source/load 106. Each channel can be implemented in a fully-differential configuration to measure potential (and spectrum) of any individual sources/loads (e.g. battery cells) of a device 470 under test (e.g. a battery stack).

The controller 108 of device 460 can be connected to each switch 410 in a given switch network by at least one data cable 464. The data cables 464 can be configured to provide bidirectional communication between the controller 108 and the measurement devices 420. Optionally, the data cables may also allow for power to be transmitted to the sensors 110/measurement devices 420 e.g. using Power over Ethernet or other protocols.

As shown in system 400, the device 460 can include a plurality of data (or data and power) ports 462a-462d. The controller 108 can be connected to each external switch network through a different data port 462 in the plurality of data ports.

As shown in FIG. 4A, the signal generator 104/analysis device 460 can be separate from the measurement devices 420 that are arranged to measure the response of the source(s)/load(s) 106. The controller 108 can provide synchronization data to each measurement device 420 through the at least one data cable 464. The synchronization data can be used by the measurement device 420 to determine when an analysis signal is applied to a given source/load 106 being monitored by that device 420. Alternatively or in addition, the synchronization data can be used to correlate the sensed data from the device 420 with the timing of an analysis signal injected by device 460. Separating the measurement device 420 and signal generator 104 also enables the sensors 110 to be positioned in close proximity to the source(s)/load(s) 106 under test. This can reduce the length of the sensing cables used to measure the response of the source(s)/load(s) 106, thereby reducing the impact of noise on the sensed data. This also allows the measurement devices 420 to be installed with a given device under test 470 to simplify analysis of sources/loads 106 that may be otherwise hard to access.

The switch network(s) 405 allows a single signal generator 104/device 460 to apply signals to a greater number of sources/loads. This can result in an increased distance between the signal generator 104 and the sources/loads 106 (e.g. upwards of 20 feet or more). Separating the measurement device 420 and signal generator 104 and synchronizing their operation through the transmission of synchronization data allows for a single device 460 to easily evaluate the performance of a large number of sources/loads 106.

The switch network 405 introduces delay in the data transmission between the controller 108 and measurement devices 420. The synchronization data (e.g. a sync signal or clock signal) can help account for this delay.

Optionally, two or more signal generators 104/analysis devices 460 may be used to measure the impedance response of a given device 470. That is, an additional signal generator 104 can be used to inject an additional analysis signal into the same device 470. This can increase the power of the signals injected into the sources/loads 106, which can improve the accuracy of the response measurements. The devices 460 can transmit synchronization data therebetween to ensure that signal injection and processing are coordinated.

As shown in FIG. 4A, the portable device 460 can include three external ports 104a, 104b, and 104c. The current flowing through each port 104 enables the portable device 460 to form a complete circuit with the DUT 470 and optionally power source/sink 102. For example, the first port 104a may have solely (or substantially solely) DC current, the second port 104b may have both AC and DC current, and the third port 104c may have solely (or substantially solely) AC current. Accordingly, the portable device 460 can establish a DC current loop through the power source/sink 102 and DUT 470 via ports 104a and 104b and an AC current loop through the DUT 470 and variable signal generator 228 via ports 104b and 104c.

Referring now to FIG. 4B, shown therein is another example system 400′ that includes an analysis device 460′, which may be a portable device. The system 400′ is generally similar to system 400 except that the analysis device 460′ omits an external coupling 104a and the power source/sink 102 has been omitted from system 400′. The analysis device 460 may omit a transformer, as illustrated in FIG. 2H. The system 400′ may be used in various operating conditions in which a power source/sink 102 is not required. For example, the system 400′ may be used where the AC signal from the signal generator 228 is sufficient to interrogate a DUT 470 (e.g. because the DUT 470 does not require biasing to enable impedance spectroscopy).

Referring now to FIG. 4C, shown therein is another example system 400″ that includes an analysis device 460″, which may be a portable device. The system 400″ is generally similar to system 400 and system 400′ except that the analysis device 460″ omits an external coupling 104c and the power supply 102 has been retained in system 400″. This may be useful for applications with limited space or where no connections are available to the DUT, e.g. in end of line applications.

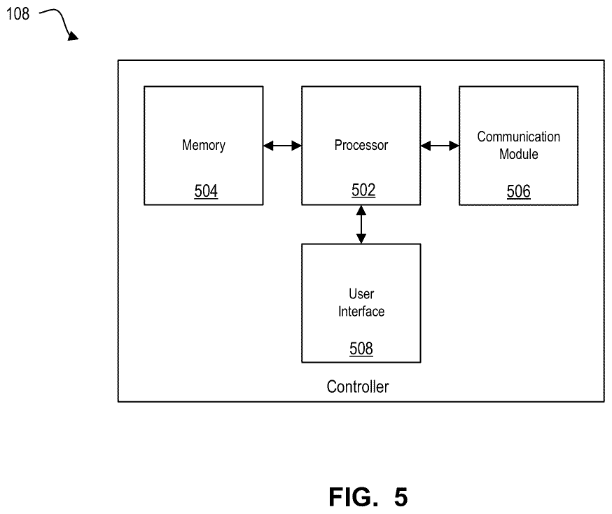

Referring now to FIG. 5, there is shown a simplified block diagram of an example controller that can be used as controller 108.

As shown in the example of FIG. 5, controller 108 generally includes a processor 502 in communication with a memory 504, a communication module 506, and a user interface 508.

Processor 502 may be configured to execute a plurality of instructions to control and operate the various components of the controller 108. Processor 502 may also be configured to receive information from the various components of controller 108 and to make specific determinations using this information. The determinations may then be transmitted to the memory device 504 and/or the communication module 506.

For example, the processor 502 may be configured to receive information, via communication module 506, from one or more of sensors 222. The processor may then use this information to determine the DC current (I_{DC}) flowing across the primary winding 210 of the transformer 208.

The processor 502 may also be configured to transmit instructions, via communication module 506, to the variable AC generator 228 to generate one or more analysis signals (I_{Analysis}) having different frequencies, or having different frequency components, within a pre-defined frequency range. The processor 502 may also be configured to transmit instructions to adjust an operational mode of the signal generator 104. For example, the processor 502 may be configured to transmit instructions to adjust the position of an internal switch network 250a-250c.

The processor 502 may be configured to receive, via the communication module 506, voltage readings from the voltage sensor 110. The processor 502 may then determine the impedance response of the corresponding device under test 106 based on a known frequency of an analysis signal injected into the device under test 106. In cases where a multi-sine signal (or multi-frequency signal) is injected into the device under test 106, the processor 502 may be further configured to de-compose the voltage reading (or current response e.g. where the analysis signal was input in the form of a voltage injection) into its separate frequency components, and accordingly, to determine the impedance response of the device under test 106 in relation to each frequency component. The processor 502 may also be configured to correlate the device's impedance response to an applied frequency in order to generate an impedance spectrum of the device under test over a range of frequencies.

The processor 502 may also be configured to transmit instructions to a measurement device 420 to identify the device under test 106 to be measured. The processor 502 can also transmit synchronization data to the measurement device 420 to ensure that measurement of the device under test is synchronized with the application of an analysis signal. The processor 502 may also identify the number of DUTs 106 coupled to the device 104.

The processor 502 may also be configured to transmit instructions to an external switch network 405 to adjust the state of the external switch network 405. The processor 502 can transmit instructions to the external switch network 405 to change the measurement device(s) 420 currently coupled to the controller 108.

The processor 502 can also transmit synchronization data to, and receive synchronization data from, the processor of another signal generator that is also injecting analysis signals into the same device 470. The processor 502 can use the synchronization data to control the operation of the signal generator so that analysis signals are injected in a coordinated manner with the other device(s).

Optionally, the instructions which are executed by the processor 502 may be transmitted from a remote terminal or other processing device (e.g. a computer, tablet or smartphone communicatively coupled to processor 502 either directly and/or through network and/or a cloud computing platform), and received by the processor 502 via communication module 506. Alternatively or in addition, the processor 502 may be pre-configured with specific instructions. The pre-configured instructions may be executed in response to specific events or specific sequences of events, or at specific time intervals.

Memory 504 may be, for example, a non-volatile read-write memory which stores computer-executable instructions and data, and a volatile memory (e.g., random access memory) that may be used as a working memory by processor 502. Alternatively or in addition, the memory 504 may be used to store determinations made by the processor 502 in respect of the impedance response of the device under test 106 for particular frequencies (or frequency components) of analysis signals that are injected therein.

Communication module 506 may be configured to send and receive data, or information, to various components of the load impedance determination system 100. For example, the communication module 506 may receive data from one or more of sensors 222 and voltage sensor 110 of the system 100.

The communication module 506 may be configured to transmit instructions to the variable AC generator 228. Accordingly, communication module 506 can be configured to provide two-way bi-directional communication.

Optionally, the communication module 506 may be configured to send and receive data to a remote terminal. For example, the communication module 506 may transmit to the remote terminal the impedance response of the device under test 106 to one or more applied analysis signals. This information may be transmitted in real-time, or near-real time, to allow an operator of the remote terminal to monitor the state and health of the device under test 106 and to take immediate corrective action if a fault is detected in the device under test 106.

The communication module 506 may also receive instructions from the remote terminal. For example, an operator of the remote terminal may transmit instructions to modify the number of analysis signals generated by the AC generator 228, the frequencies (or frequency components) of the analysis signals generated by the AC generator 228, and/or the frequency range of the generated analysis signals.

Optionally, the communication module 506 may transmit and receive data and information from an external controller (not shown) which is coupled to the device under test 106. For example, the external controller may be configured to modify the operation of the device under test 106 based on information received about the impedance response of the device under test 106. The communication module 506 may also transmit impedance information to the external controller in real-time, or near real time.

The communication module 506 may, for example, include a wireless transmitter or transceiver and antenna. Alternatively or in addition, the communication module 506 may be configured for wired communication. Optionally, the communication module 506 may be configured for communication over public or private wired or wireless networks.

The controller 108 may also include a user interface 508. The user interface 508 may be one or more device that allows a user, or operator, to interact with the controller 108. For example, the user interface 508 may have a keyboard or other input device that allows a user to input instructions into the controller 108 with respect to the operation of the load impedance determination system 100. For example, in some cases, the user may input instructions to control the number of analysis signals generated by the AC generator 228, or the frequencies of the analysis signals generated by the AC generator 228 (or the frequency components of a mixed-frequency analysis signal). The user may input instructions to control the frequency range of the analysis signals generated by the AC generator 228. Accordingly, the user interface 508 may allow direct control of the system 100 without requiring a remote terminal.

Optionally, the user interface 508 may also include a display that allows the user to view the determined impedance response of the device under test 106 in response to different frequencies of analysis signals injected into the device under test 106. The display may allow the user to view the impedance response of the device under test in real-time, or near real time, to allow the user to monitor the state and health of the device under test 106, and accordingly, to take immediate corrective action if a fault is detected. The user interface 508 may further include a graphical user interface (GUI) which facilitates user interaction.

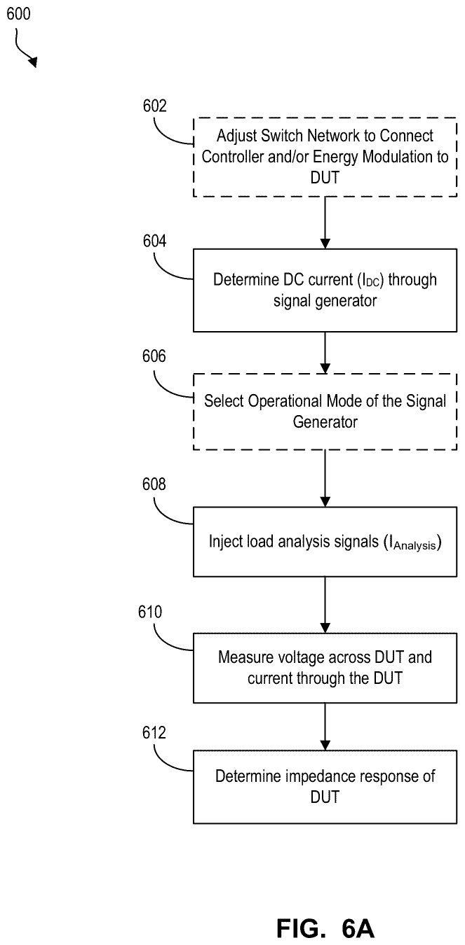

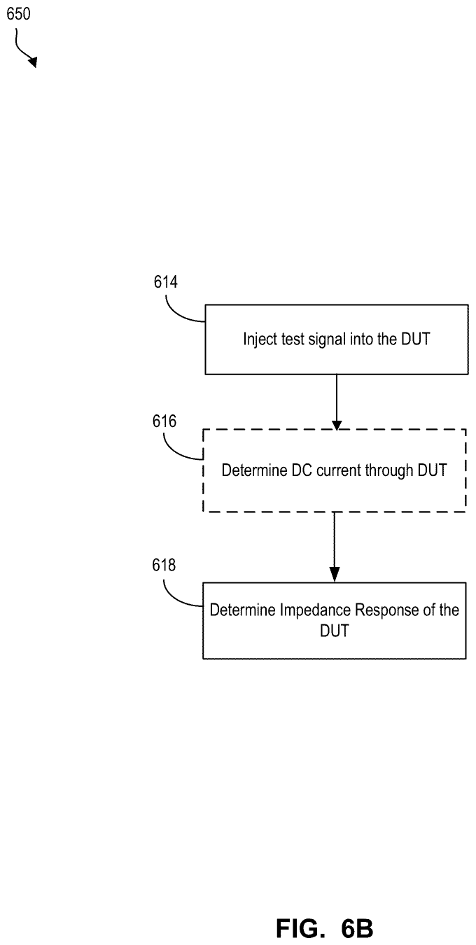

Referring now to FIG. 6A, there is shown a process flow for an example method 600 for determining the impedance properties of the device under test 106. The method 600 can be carried out, for example, using processor 502 of the controller 108 in FIG. 5. It should be understood that the process flow shown in FIG. 6A is merely exemplary and that the steps 602-612 may be performed in a different sequence than that shown and some steps may be performed concurrently or in parallel. Furthermore, certain steps or combinations of steps may be performed multiple times (e.g. iteratively) to ensure that the impedance response of the DUT can be measured effectively.

Optionally, at 602, the controller 108 is selectively connected to a particular device under test 106. Further optionally, energy modulation circuitry 230 may also be connected to the device under test 106. For example, the controller 108 and/or energy modulation circuitry 230 can be selectively connected to the DUT 106 using the external switch network 405.

At 604, the DC current (I_{DC}) through the signal generator can be determined. For example, the DC current (I_{DC}) flowing across the primary winding 210 of the transformer 208 may be determined. As stated previously, the DC current (I_{DC}) may be determined using information received from one or more sensors 222.

Optionally, at 606 the operational mode of the signal generator 104 can be selected. The operational mode of the signal generator 104 may be selected from amongst a plurality of operational modes. The circuit configuration can be adjusted if necessary to provide the selected operational mode. Optionally, the operational mode of the power source/sink 102 may also be adjusted as required (e.g. between a power supply/source mode and a power sink mode).

At 608, the variable AC generator 228 generates one or more analysis signals (I_{Analysis}) having different frequencies, or frequency components, for injection into the device under test 106. The analysis signals are injected in accordance with the operational mode selected at 606.

At 610, the voltage across, and current through the device under test 106 may be measured. For instance the voltage may be measured using voltage sensor 110, and the current may be measured using current sensor 222b.

At 612, based on the measurements at 610, the impedance of the device under test 106 may be determined in response to each frequency (or frequency component) of the analysis signals injected into the device under test 106.

Referring now to FIG. 6B, shown therein is an example process 650 for testing an initial impedance response of a DUT prior to injecting an analysis signal. The example process 650 can be used to determine various operating parameters of the system 100, for example a desired operational mode of the signal generator, a switch network configuration, and/or operating parameters of the power supply/sink.

At 614, a test signal can be injected into the DUT 106. The impedance response of the DUT 106 to the test signal can then be determined at 618. The impedance response of the DUT 106 to the test signal can be used to determine the desired or optimal operational mode prior to selecting the operational model of the signal generator at 606.

Optionally, a desired or optimal operational mode may be determined prior to selecting the operational mode at 606. For example, method 650 may be used to determine a desired operational mode for the signal generator. The example method 650 may be performed as part of, or prior to, selecting the operational mode of the signal generator at step 606.

Optionally, the operational mode of the power supply/sink may also be determined based on the initial impedance response of the DUT. For example, the process 650 may be used to determine a minimum DC bias level for the DUT to enable the impedance response to be evaluated. Accordingly, method 650 may also include a step 616 of measuring the DC current through the DUT when injected with the test signal.

For example, the controller 108 can be configured to determine a minimum amount of DC current to inject into a DUT. This may be help reduce the power requirements of the impedance determining system. This may be particularly desirable for implementations in which testing is performed on a regular basis, for instance during end of line testing for a given device under test.

The minimum DC current level may be determined based on the impedance level of the DUT when unbiased. For DUTs with high levels of unbiased impedance (e.g. an electrolyzer), a higher minimum DC current level may be required to ensure that the impedance spectrum of the DUT can be determined. For DUTs with low levels of unbiased impedance, a lower minimum DC current level (sometimes zero) may be required to ensure that the impedance spectrum of the DUT can be determined.

Determining the minimum DC current level can before performed through a potentially iterative process of measuring the impedance of the DUT, adjusting the level of the DC, and re-testing the impedance of the DUT until the measured data is sufficient to determine the impedance spectrum of the DUT.

For example, an initial level of DC current can be input to the DUT. The initial level may be zero or a level of current slightly above zero. An analysis signal can be injected to the DUT superimposed on the initial level of DC current and the impedance response can be measured. The response can be analyzed to determine whether the impedance spectrum of the DUT can be accurately assessed.

If the level of DC current is sufficient to enable the impedance spectrum of the DUT to be assessed, then the minimum DC current level can be defined as that level of DC current. If the level of DC current is insufficient to enable the impedance spectrum of the DUT to be appropriately characterized, then the level of DC current can be increased. An analysis signal can be injected to the DUT superimposed on the increased level of DC current and the impedance response can be measured. The response can be analyzed to determine whether the impedance spectrum of the DUT can be accurately assessed. This process can be repeatedly iteratively until the minimum DC current level is determined.

The present invention has been described here by way of example only, while numerous specific details are set forth herein in order to provide a thorough understanding of the exemplary embodiments described herein. However, it will be understood by those of ordinary skill in the art these embodiments may, in some cases, be practiced without these specific details. In other instances, well-known methods, procedures and components have not been described in detail so as not to obscure the description of the embodiments. Various modifications and variations may be made to these exemplary embodiments without departing from the spirit and scope of the invention, which is limited only by the appended claims.

We claim:

1. A system for analysing a device under test, the system comprising:
a transformer having at least one primary winding and at least one secondary winding;
the at least one primary winding of the transformer being coupled in series between a power supply or sink and an output connectable to a device under test, wherein the power supply or sink is operable in a power supply mode to generate a DC current across the at least one primary winding to power the device under test and the power supply or sink is operable in a power sink mode to dissipate electrical energy from the device under test;
a variable alternating-current (AC) generator configured to generate at least one device analysis signal; and
a controller operably connectable to at least one first sensor, wherein the at least one first sensor is configured to measure at least one attribute of the device under test, wherein the controller is configured to receive a first input signal from the at least one first sensor,
wherein the system is operable in a first mode and a second mode, wherein when the system is in the first mode the variable AC generator is coupled to the device under test to apply the at least one analysis signal to the device and a controlled energy device is coupled in series between the variable AC generator and the device under test.

2. The system of claim 1 wherein the controller is configured to determine impedance properties of the device under test based on the first input signal.

3. The system of claim 1, when the system is in the first mode, the at least one secondary winding is disconnected.

4. The system of claim 1, wherein when the system is in the second mode, the variable AC generator is coupled in-series to the at least one secondary winding.

5. The system of claim 1, wherein when the system is in the second mode the controlled energy device is coupled to the device under test in parallel with the power supply or sink.

6. The system of claim 1, wherein the controller is connectable to the at least one first sensor by a data cable.

7. The system of claim 6, wherein the controller is operable to provide power to the at least one first sensor through the data cable.

8. The system of claim 1, wherein the controller is operably connectable to a first measurement device, wherein the first measurement device comprises the at least one first sensor, the at least one first sensor comprises a plurality of first sensors, and each first sensor is operably connectable to a different corresponding load or source of the device under test.

9. The system of claim 8, further comprising an external switch network, wherein the controller is selectively connectable to a plurality of measurement devices via the external switch network.

10. The system of claim 9, wherein each measurement device comprises a corresponding plurality of first sensors, and each first sensor is operably connectable to a different corresponding load or source of the device under test.

11. The system of claim 9, wherein the external switch network comprises a plurality of external switches, and the plurality of external switches are connected to the controller in a series with each external switch coupled to at least one adjacent external switch in the series.

12. The system of claim 11, wherein the plurality of external switches are daisy-chained to the controller.

13. The system of claim 9, wherein the controller is connectable to each switch in the switch network by at least one data cable.

14. The system of claim 13, wherein the controller is operable to provide synchronization data to each measurement device through the at least one data cable.

15. The system of claim 9, further comprising at least one additional external switch network, wherein the controller is selectively connectable to an additional plurality of measurement devices via each additional external switch network.

16. The system of claim 15, wherein the controller comprises a plurality of data ports, and the controller is connectable to each external switch network through a different data port in the plurality of data ports.

17. The system of claim 9, wherein the controller is detachably attachable to the external switch network.

18. The system of claim 1, wherein each first sensor comprises a first voltage sensor connectable in parallel arrangement to the corresponding load or source of the device under test.

19. The system of claim 1, wherein the transformer, variable AC generator, controller and controlled energy device are provided by a portable analysis device.

20. The system of claim 1, wherein the at least one first sensor remains connected to the load or source of the device under test.

21. The system of claim 1, wherein the power supply or sink is a bidirectional power supply.
